(19) United States
(12) Patent Application Publication
(10) Pub. No.: US 2025/0106922 A1
(43) Pub. Date: Mar. 27, 2025

(54) INTER-DU MULTI-TRP OPERATION

(71) Applicant: Nokia Technologies Oy, Espoo (FI)

(72) Inventors: Subramanya CHANDRASHEKAR, Bangalore (IN); Srinivasan SELVAGANAPATHY, Bangalore (IN); Tero HENTTONEN, Espoo (FI); Ahmad AWADA, Munich (DE); Panagiotis SPAPIS, Munich (DE); Amaanat ALI, Espoo (FI)

(21) Appl. No.: 18/730,838

(22) PCT Filed: Jan. 13, 2023
(86) PCT No.: PCT/EP2023/050678

§ 371 Date: Jul. 22, 2024

(30) Foreign Application Priority Data
Jan. 20, 2022 (IN) 202241003331

(51) Int. Cl. H04W 76/16; H04W 24/10; H04W 72/23

(52) U.S. Cl. CPC H04W 76/16; H04W 24/10; H04W 72/23

(57) ABSTRACT

An apparatus includes circuitry configured to transmit downlink data to a user equipment for at least one serving cell and at least one assisting cell; receive uplink data from the user equipment; wherein the serving cell is hosted with a serving distributed node, and the assisting cell hosted with an assisting distributed node; transmit control plane signaling, to configure and manage inter distributed unit multi transmission reception point operation, from the serving node to the assisting node using a control plane node, and transmit control plane signaling from the assisting node to the serving node using the control plane node; and transmit user plane data from the serving node to the assisting node using a user plane node for downlink multi transmission reception point operation, and transmit user plane data from the assisting node to the serving node using the user plane node for uplink multi transmission reception point operation.

### TECHNICAL FIELD

The examples and non-limiting embodiments relate generally to communications and, more particularly, to inter-DU multi-TRP operation.

### BACKGROUND

It is known to implement a plurality of radio access network nodes in a communication network.

### SUMMARY

In accordance with an aspect, an apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; transmit control plane signaling, to configure and manage inter distributed unit multi transmission reception point operation, from the serving distributed node to the assisting distributed node using a control plane node, and transmit control plane signaling from the assisting distributed node to the serving distributed node using the control plane node; and transmit user plane data from the serving distributed node to the assisting distributed node using a user plane node for downlink multi transmission reception point operation, and transmit user plane data from the assisting distributed node to the serving distributed node using the user plane node for uplink multi transmission reception point operation.

In accordance with an aspect, an apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; wherein the serving distributed node determines a data split ratio between the serving cell and the assisting cell associated with inter distributed node multiple transmission reception point operation; wherein the data split ratio between the serving cell and the assisting cell is transmitted from the serving distributed node to the control plane node during a setup of multiple transmission reception point operation; wherein a change in the data split ratio between the serving cell and the assisting cell is transmitted from serving distributed node to the user plane node using a control protocol data unit; transmit a first stream of data from a user plane node to the serving distributed node using a first user plane link; and transmit a second stream of data from the user plane node to the assisting distributed node using a second user plane link.

In accordance with an aspect, an apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; transmit, from the serving distributed node to the assisting distributed node over an interface, a request for configuring the user equipment with multiple transmission reception point operation; and transmit, from the assisting distributed node to the serving distributed node over the interface, a response to the request for multiple transmission reception point operation.

In accordance with an aspect, a system includes a user equipment; at least one network node that hosts at least one serving cell and at least one assisting cell; wherein the user equipment is configured to receive downlink data from the at least one network node within at least one serving cell and within the at least one assisting cell; wherein the user equipment is configured to transmit uplink data to the at least one network node within the at least one serving cell and within the at least one assisting cell; serving distributed node; and an assisting distributed node; wherein the serving distributed node and the assisting distributed node is controlled by the same control plane node and exchange information using at least one of the control plane node, at least one user plane link, or a direct interface.

In accordance with an aspect, an apparatus includes at least one processor; and at least one memory including computer program code; wherein the at least one memory and the computer program code are configured to, with the at least one processor, cause the apparatus at least to: receive uplink data from a user equipment, and transmit downlink data to the user equipment; provide, for the user equipment, access to at least one serving cell; serve, from a hybrid automatic repeat request buffer, data to a serving cell transmission reception point; transmit control plane information to an assisting cell distributed node; and transmit user plane data to the assisting cell distributed node.

In accordance with an aspect, an apparatus includes at least one processor; and at least one memory including computer program code; wherein the at least one memory and the computer program code are configured to, with the at least one processor, cause the apparatus at least to: receive uplink data from a user equipment, and transmit downlink data to the user equipment; provide, for the user equipment, access to at least one assisting cell; receive control plane information from a serving cell distributed node to configure multiple transmission reception point for a user equipment; and receive user plane data from the serving cell distributed node.

In accordance with an aspect, an apparatus includes at least one processor; and at least one memory including computer program code; wherein the at least one memory and the computer program code are configured to, with the at least one processor, cause the apparatus at least to: receive a layer 3 measurement report from a user equipment; configure a serving distributed node with multiple transmission reception point operation for a user equipment; receive control plane signaling from the serving distributed node; transmit the control plane signaling to an assisting distributed node; wherein the control plane signaling is configured to be used for multiple transmission reception point operation; and configure the user equipment with multiple transmission reception point operation in downlink and/or uplink.

In accordance with an aspect, an apparatus includes at least one processor; and at least one memory including computer program code; wherein the at least one memory and the computer program code are configured to, with the at least one processor, cause the apparatus at least to: receive, from a control plane node, a bearer context setup request; transmit, to the control plane node, a response to the bearer context setup request; receive, from the control plane node, a bearer context modification request; transmit, to the control plane node, a response to the bearer context modification request; wherein the bearer context setup request and the bearer context modification request are related to multiple transmission reception operation; and provide an indication for transparent forwarding as part of the multiple transmission reception point operation.

In accordance with an aspect, a method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; transmitting control plane signaling, to configure and manage inter distributed unit multi transmission reception point operation, from the serving distributed node to the assisting distributed node using a control plane node, and transmitting control plane signaling from the assisting distributed node to the serving distributed node using the control plane node; and transmitting user plane data from the serving distributed node to the assisting distributed node using a user plane node for downlink multi transmission reception point operation, and transmitting user plane data from the assisting distributed node to the serving distributed node using the user plane node for uplink multi transmission reception point operation.

In accordance with an aspect, a method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; wherein the serving distributed node determines a data split ratio between the serving cell and the assisting cell associated with inter distributed node multiple transmission reception point operation; wherein the data split ratio between the serving cell and the assisting cell is transmitted from the serving distributed node to the control plane node during a setup of multiple transmission reception point operation; wherein a change in the data split ratio between the serving cell and the assisting cell is transmitted from serving distributed node to the user plane node using a control protocol data unit; transmitting a first stream of data from a user plane node to the serving distributed node using a first user plane link; and transmitting a second stream of data from the user plane node to the assisting distributed node using a second user plane link.

In accordance with an aspect, a method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; transmitting, from the serving distributed node to the assisting distributed node over an interface, a request for configuring the user equipment with multiple transmission reception point operation; and transmitting, from the assisting distributed node to the serving distributed node over the interface, a response to the request for multiple transmission reception point operation.

In accordance with an aspect, a method includes receiving uplink data from a user equipment, and transmit downlink data to the user equipment; providing, for the user equipment, access to at least one serving cell; serving, from a hybrid automatic repeat request buffer, data to a serving cell transmission reception point; transmitting control plane information to an assisting cell distributed node; and transmitting user plane data to the assisting cell distributed node.

In accordance with an aspect, a method includes receiving uplink data from a user equipment, and transmit downlink data to the user equipment; providing, for the user equipment, access to at least one assisting cell; receiving control plane information from a serving cell distributed node to configure multiple transmission reception point for a user equipment; and receiving user plane data from the serving cell distributed node.

In accordance with an aspect, a method includes receiving a layer 3 measurement report from a user equipment; configuring a serving distributed node with multiple transmission reception point operation for a user equipment; receiving control plane signaling from the serving distributed node; transmitting the control plane signaling to an assisting distributed node; wherein the control plane signaling is configured to be used for multiple transmission reception point operation; and configuring the user equipment with multiple transmission reception point operation in downlink and/or uplink.

In accordance with an aspect, a method includes receiving, from a control plane node, a bearer context setup request; transmitting, to the control plane node, a response to the bearer context setup request; receiving, from the control plane node, a bearer context modification request; transmitting, to the control plane node, a response to the bearer context modification request; wherein the bearer context setup request and the bearer context modification request are related to multiple transmission reception operation; and providing an indication for transparent forwarding as part of the multiple transmission reception point operation.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 is a block diagram illustrating a disaggregated gNB architecture, based on the examples described herein.

FIG. 3 is a diagram illustrating L1/L2 centric inter-cell mobility scenarios.

FIG. 4 is a diagram depicting intra-DU mTRP where serving and assisting cells belong to the same DU.

FIG. 5 is a diagram depicting an inter-DU mTRP first alternative, implementing a DU-DU interface via a CU.

FIG. 6 is a diagram depicting an inter-DU mTRP second alternative, using NR-DC principles.

FIG. 7 is a diagram depicting an inter-DU mTRP third alternative, implementing a DU-DU direct interface.

FIG. 8 is a signaling diagram of a process flow implementing the inter-DU mTRP first alternative shown in FIG. 5.

FIG. 9 is a signaling diagram of a process flow implementing the inter-DU mTRP second alternative shown in FIG. 6.

FIG. 10 is a signaling diagram of a process flow implementing the inter-DU mTRP third alternative shown in FIG. 7.

FIG. 11 is an example apparatus configured to implement the examples described herein.

FIG. 12 is an example method to implement the examples described herein.

FIG. 13 is an example method to implement the examples described herein.

FIG. 14 is an example method to implement the examples described herein.

FIG. 15 is an example method to implement the examples described herein.

FIG. 16 is an example method to implement the examples described herein.

FIG. 17 is an example method to implement the examples described herein.

FIG. 18 is an example method to implement the examples described herein.

### DETAILED DESCRIPTION OF EXAMPLE EMBODIMENTS

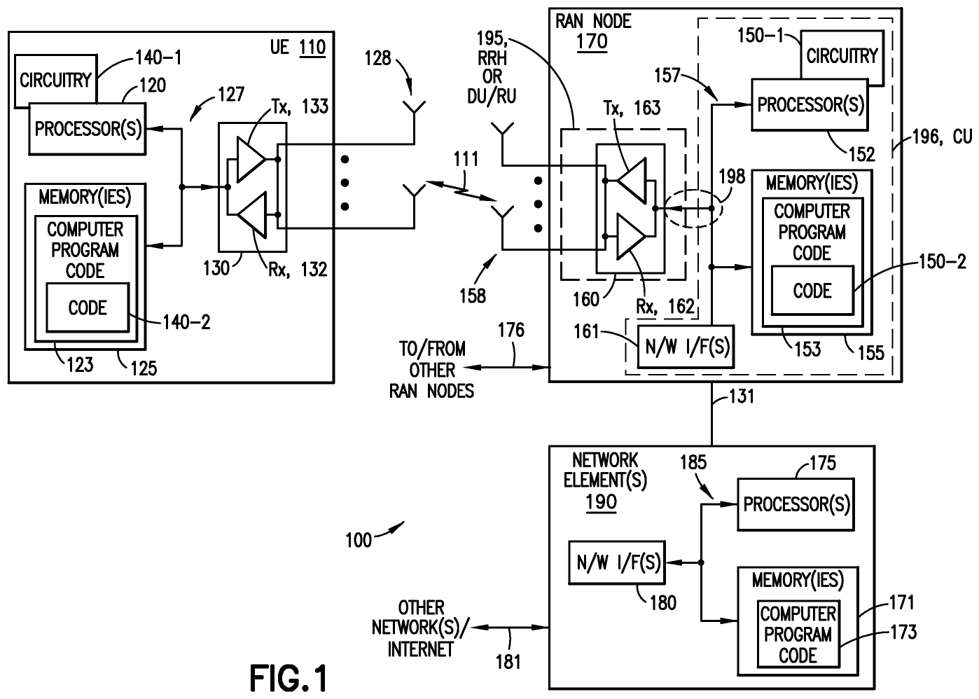

Turning to FIG. 1, this figure shows a block diagram of one possible and non-limiting example of an illustration of a wireless network 100 in which the examples may be practiced. A user equipment (UE) 110, a radio access network (RAN) node 170, and a network element(s) 190 are illustrated. In the example of FIG. 1, the user equipment (UE) 110 is in wireless communication with RAN node 170. A UE is a device with a radio interface to access the wireless network 100. The UE 110 includes e.g. one or more processors 120, one or more memories 125 (with computer program code stored thereon), and one or more transceivers 130 interconnected through one or more buses 127 or other wired connections. At least one of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. At least one of the one or more transceivers 130 is connected to at least one or more antennas 128. At least one of the one or more memories 125 includes computer program code 123. The UE 110 includes circuitry 140-1 and/or code 140-2, which may be implemented in a number of ways. The circuitry 140-1 may be implemented in hardware, such as being implemented as part of the one or more processors 120. The circuitry 140-1 may be implemented also as an integrated circuit or through other hardware such as a programmable gate array. In another example, code 140-2, may be implemented as computer program code 123 and is executable by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless or radio link 111. Circuitry 140-1 and/or code 140-2 may provide L2 and/or L3 functionality, e.g. L2 and/or L3 control plane signal processing.

The RAN node 170 in this example is a base station that provides access to the UE 110. The RAN node 170 may be, for example, a base station for 5G, also called New Radio (NR). In 5G, the RAN node 170 may be a NG-RAN node, e.g. a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs. A gNB may include a central unit (CU) (gNB-CU) 196 and one or more distributed unit(s) (DUs) (gNB-DUs), of which DU 195 is shown. Note that the DU 195 may include or be coupled to and control a radio unit (RU). The gNB-CU 196 is a logical node which may host radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node which may host RLC, MAC and PHY layers of the gNB or en-gNB, and its operation is partly controlled by gNB-CU 196. One gNB-DU 195 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the gNB-DU 195 may include at least one processor and at least one memory with computer program code stored thereon, and the transceiver 160, e.g., as part of a Radio Unit (RU), but some examples of this may have the transceiver 160 as part of a separate RU, e.g., under control of and connected to the gNB-DU 195. The one or more transceivers 160 are connected to one or more antennas 158. The gNB-DU 195 may further include circuitry and/or code which may provide L2 functionality, e.g. L2 control plane signal processing. The RAN node 170 may also be an eNB (evolved NodeB) base station, for LTE (long term evolution), or any other suitable base station or node.

The gNB-CU 196 (and/or RAN node 170) may include one or more processors 152, one or more memories 155, one or more network interfaces (N/W I/F(s)) 161, interconnected through one or more buses 157 or other wired connections. At least one of the one or more memories 155 includes computer program code 153, e. g. computer-readable instructions. The DU 195 may also contain its own memory/memories and processor(s), and/or other hardware.

The RAN node 170 (and/or CU 196 and/or DU 195) includes circuitry 150-1 and/or code 150-2, which may be implemented in a number of ways. The circuitry 150-1 may be implemented in hardware, such as being implemented as part of the one or more processors 152. The circuitry 150-1 may be implemented also as an integrated circuit or through other hardware such as a programmable gate array. In another example, code 150-2, may be implemented as computer program code 153 and is executable by the one or more processors 152. For instance, the one or more memories 155 and the computer program code 153 may be configured to, with the one or more processors 152, cause the gNB-CU 196 (and/or RAN node 170 and/or DU 195) to perform one or more of the operations as described herein. Circuitry 150-1 and/or code 150-2 may provide L3 functionality, e.g. L3 control plane signal processing.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform combined virtualization, often with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

Accordingly, UE 110, RAN node 170, and/or network element(s) 190, (and associated memories, computer program code and modules) may be configured to implement (e.g. in part) the examples described herein, including inter-DU multi-TRP operation. Thus, computer program code 123, circuitry 140-1, code 140-2, and other elements/features shown in FIG. 1 of UE 110 may be configured to implement user equipment related aspects of the examples described herein. Similarly, computer program code 153, circuitry 150-1, code 150-2, and other elements/features shown in FIG. 1 of RAN node 170, including the CU 196 and DU 195, may be configured to implement RAN/gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

The examples described herein are related to mTRP operation, including mobility enhancement in MR-DC, NR-DC and CA.

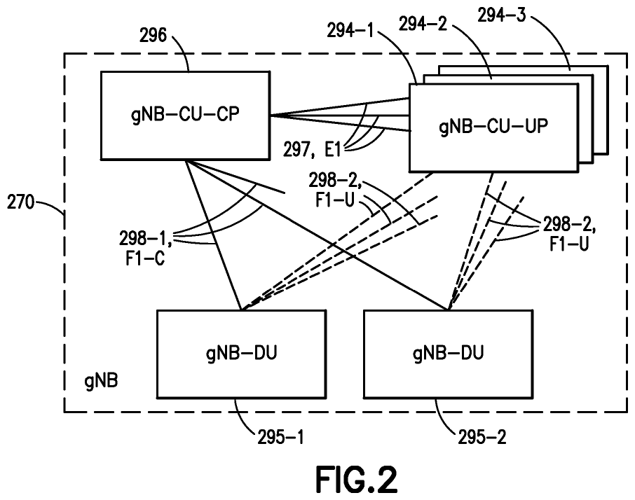

With reference to FIG. 2, the disaggregated architecture is defined in 3GPP decomposing the gNB 270 e.g. into multiple logical entities. Likewise, a single DU may host multiple cells of 512 (max in current specifications). In an exemplary embodiment the gNB-CU-CP 296 hosts the PDCP (c) and RRC layers, while the gNB-DU (295-1 and 295-2) hosts the RLC, MAC and PHY layers. The scheduling operation takes place at the gNB-DU (295-1, 295-2). The gNB-CU-UP hosts the PDCP (u) and SDAP layers.

FIG. 2 further shows the gNB-CU-CP 296 connected to each of the gNB-DU (295-1, 295-2) via a plurality of respective F1-C interfaces (collectively 298-1), and the gNB-CU-CP 296 connected to a plurality of gNB-CU-UPS (294-1, 294-2, 294-3) via a plurality of respective E1 interfaces (collectively 297). Each gNB-DU (295-1, 295-2) is connected to each of gNB-CU-UP 294-1, gNB-CU-UP 294-2, and gNB-CU-UP 294-3 via a plurality of respective F1-U interfaces (collectively 298-2).

Likewise, any given cell may consist of multiple beams served by different transmission points (TRPs). As of Release 16, it is possible for a UE to transmit and receive data via multiple beams as long as these belong to the same cell (i.e. the same PCI).

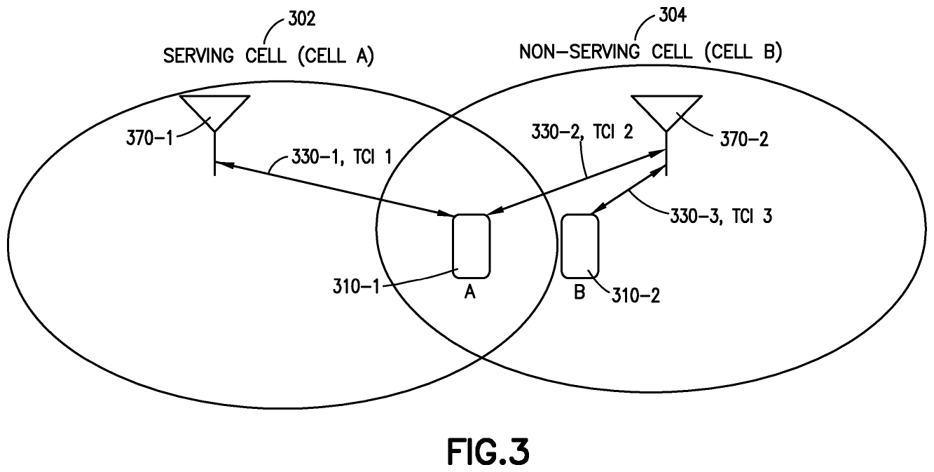

With reference to FIG. 3, there is an ongoing Release 17 RAN1-led NR_feMIMO work item in 3GPP (expected to impact RAN1-4 WGs), which extends the multiTRP (mTRP) operation to support transmission and reception of multiple beams from different cells, with a limitation that these cells must belong to the same gNB-DU. Likewise, potential change of the serving cell via L1/L2 mechanisms is out of scope in release 17. The details of this WI can be found in [RP-193133 New WID: Further enhancements on MIMO for NR].

FIG. 3 shows an example of an mTRP scenario. In FIG. 3, TCI 1 (330-1) is transmitted between the UE A (310-1) and TRP 370-1 located in the serving cell (cell A) 302. TCI 2 (330-2) is transmitted between UE A 310-1 and TRP 370-2 located in the non-serving cell (cell B) 304. TCI 3 (330-3) is transmitted between UE B 310-2 and TRP 370-2 located in the non-serving cell (cell B) 304. A serving cell is associated with a UE, i.e., any cell becomes a serving cell when it serves a UE. Thus, cell A 302 is a non-serving cell with respect to UE B 310-2.

Although Release 17 is limited to intra-DU mTRP operation, there is significant operator and vendor demand to continue further work in Rel 18 with a broader scope and is likely to be agreed to as well. This would extend the support also for change of serving-cell via L1/L2 based mechanisms in both intra-DU and inter-DU scenarios.

In order to support L1/L2 centric inter-cell change (i.e. change of serving cell) in the disaggregated gNB architecture, a new mechanism is needed in which configuration would be generated and delivered by the gNB-CU-CP, but executed autonomously by the gNB-DU without further interaction with the upper layers.

This includes two aspects, namely 1) multi TRP operation involving serving and assisting cells, including both intra-DU and inter-DU scenarios, and 2) L1/L2 centric inter-cell change, including both intra-DU and inter-DU scenarios.

Some definitions used in this disclosure are as follows:

mTRP operation: simultaneous DL/UL transmission in serving and assisting cell TRPS.

assisting cell: a non-serving cell which is used to assist a UE in multi-TRP operation. It may belong to the same DU or a different DU hosting the serving cell, but belongs to the same gNB-CU, as per the scope of 3GPP Rel 18.

As the examples described herein pertain to Rel 18 WI scope, the official status is in RP-212710, and further input is in RP-213357.

No obvious solution exists for inter-DU mTRP, since there is both CP and UP communication between the two DUs involved in mTRP operation and a DU-DU interface is not a part of the 5G architecture.

The examples described herein provide a framework to realize inter-DU multi-TRP operation and optimizations for the same without the additional overhead and delays.

Since inter-DU mTRP is not in the scope of R17, either solution is feasible, and any of the solutions as described herein may be implemented in R18.

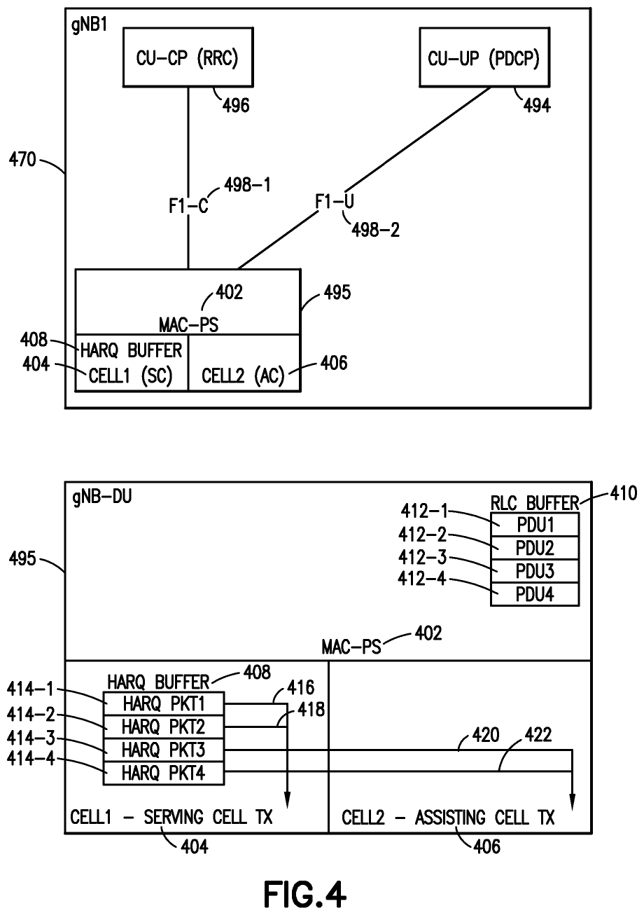

With reference to FIG. 4, intra-DU mTRP is one where serving cells (e.g. 404) and assisting cells (e.g. 406) belong to the same DU (495). Intra-DU mTRP can be visualized as shown in FIG. 4. Since the configuration shown in FIG. 4 is internal to the DU 495, the configuration can be assumed to be implementation-specific.

The intra-DU mTRP working principle involves: i) a single F1-U link 498-2 between the CU-UP 494 and the serving DU 495, i.e. only one stream of data; ii) a single RLC buffer 410 and HARQ buffer 408; iii) the MAC Packet Scheduler (PS) 402 is notified of the DL throughput shared between the serving cells e.g. 404 and assisting cells e.g. 406 (where the serving cell 404, HARQ packet transmission 416, and HARQ packet transmission 418 are distinguished from the F1-U link 498-2, assisting cell 406, HARQ packet transmission 420, and HARQ packet transmission 422); iv) scheduling is performed from a single HARQ buffer 408.

An alternative is having a HARQ buffer in both cells 404 and 406. The packets (414-1, 414-2, 414-3, 414-4) are duplicated in both cells (404, 406) and transmission occurs based on the best radio conditions. This increases reliability of the user plane but doesn't enhance the data rate.

Additionally having the HARQ buffer 408 in both cells 404 and 406 requires independent PDCCH and PDSCH for both serving and assisting cells and ends up in independent transmissions as well. UE vendors are not keen, as having the HARQ buffer 408 in both cells 404 and 406 requires heavy implementation effort.

As further shown in FIG. 4, the gNB 470 includes a CU-CP (RRC) 496 connected to the DU 495 with an F1-C link 498-1. The RLC buffer 410 includes PDU1 412-1, PDU2 412-2, PDU3 412-3, and PDU4 412-4.

Accordingly, described herein is a framework and enhancements to configure an inter-DU mTRP operation using 3 methods. Three approaches are proposed, namely 1. inter-DU mTRP using DU-DU communication via CU (both CP and UP), 2. inter-DU mTRP based on NR-DC principles, and 3. inter-DU mTRP using a DU-DU interface.

Inter-DU mTRP using DU-DU communication via a CU (both CP and UP) is the most straight-forward mTRP solution in the absence of a DU-DU interface, which is implemented using the CU-CP for relaying CP signaling, and using the CU-UP for relaying UP data.

Inter-DU mTRP based on NR-DC principles involves two cell groups (MCG, SCG) and a complete redesign of the dual connectivity principles, which is not aligned to the principles of mTRP operation. In NR-DC, SCG is e.g. handled autonomously by a SN, while the assisting cell is under complete control of the serving cell in mTRP operation (as per intra cell mTRP and inter-cell mTRP (intra DU) defined until now in R16 and R17).

Inter-DU mTRP using a DU-DU interface may or may not be applicable in the scope of 5G, but considering that a DU-DU interface may appear in 6G, certain embodiments could be considered here as well.

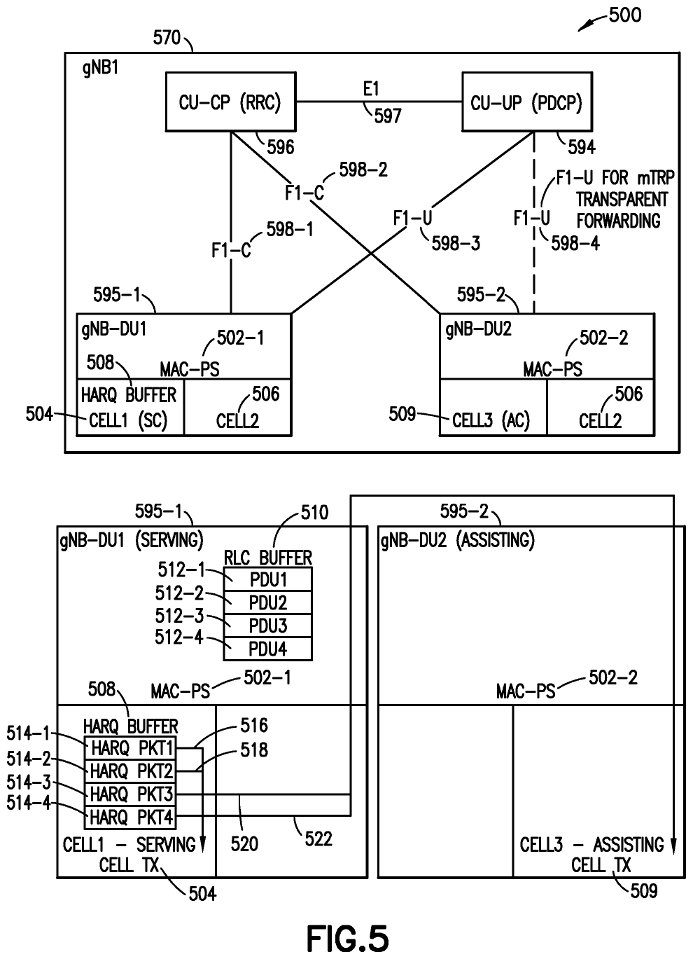

FIG. 5 depicts alternative 1 500, namely inter-DU mTRP using a DU-DU interface via the CU.

For alternative 1, implemented is a single F1-U link 598-3 between the CU-UP 594 and the serving DU 595-1 associated with mTRP operation, i.e. only one stream of DL data, where the serving DU's HARQ buffer 508 feeds data to both the serving cell TRP 595-1 and the assisting cell TRP 595-2. Data-split is performed from the single HARQ buffer 508.

The framework for alternative 1 is that the serving DU 595-1 assigns an mTRP-RNTI. The mTRP-RNTI is provided to the CU-CP 596 over F1 598-1 and forwarded to CU-UP 504 over E1 597. The mTRP-RNTI is used at the CU-UP 594 to identify MAC PDUs of a UE in mTRP operation. Alternatively, the mTRP-RNTI can be allocated by the CU-CP 596 as well. The mTRP-RNTI could be also used as an indicator to the DU 595-1 to configure mTRP for the UE 110 in F1: UE Context Setup Request (e.g. via F1-C 598-1).

The CU-CP 596 shares the DL TEID of the assisting DU 595-2 and the mTRP-RNTI to the CU-UP 594. The DL TEID is used by the CU-UP 594 to transparently forward the received mTRP associated MAC PDU over F1-U 598-4 (without decoding the payload) from the serving DU.

The mTRP MAC PDU is constructed by the serving DU 595-1 using a MAC PDU+Header. The MAC PDU internally consists of the HARQ packet. The Header is proposed to include the mTRP-RNTI (e.g.: UE ID) in the serving cell 504. The Header is sent from the serving DU 595-1 to the CU-CP 596 which further sends the Header to the assisting DU 595-2 during assisting cell setup (e.g. setup of cell 509). This process of transmission is needed to identify mTRP UE data at the assisting DU 595-2. The assisting DU 595-2 removes the Header and sends the MAC PDU to the UE 110.

Transfer (of data (MAC PDU)) from the serving DU 595-1 to the assisting DU 595-2 may happen via a DU-DU (data) interface (if available) or via the F1-U interface (e.g. 598-3 and/or 598-4) (serving DU 595-1 to CU-UP 594 to assisting DU 595-2).

A similar mechanism for identification of the UE 110 and tunnel points is also configured for uplink transfer of the received MAC-PDU from the target cell to the serving cell 504. The CU-CP 596 shares the UL TEID of the serving DU 595-1 (shared by the serving DU 595-1 to the CU-CP 596 during a UE context setup response for the serving cell 504) to the assisting DU 595-2 and the CU-UP 594. Upon receiving a HARQ PDU from the UE 110, the assisting cell 509 constructs the MAC PDU by attaching a header to the HARQ PDU where the header contains the mTRP-RNTI (shared by the CU-CP 596) to help the CU-UP 594 identify that the HARQ PDU is for mTRP UE data. The CU-UP 594 transparently forwards the header with the HARQ PDU to the serving DU 595-1 which sends the merged UL data (serving+assisting UL MAC PDUs) to the CU-UP 594.

Regarding downlink scheduling at the assisting DU 595-2, the CU-CP 596 sends assistance information (expected min and max grant) to the assisting DU 595-2 during setup of mTRP operation. The assisting DU 595-2 sends to the serving DU 595-1 (via the CU-CP 596) over F1-C (598-2, 598-1), the MAC PDU sizes and initial allocated scheduling grant for the UE 110. The serving DU 595-1 uses the MAC PDU sizes and initial allocated scheduling grant for the UE 110 to perform data split between serving cells e.g. 504 and assisting cells e.g. 509. In some special cases, data can be duplicated to improve reliability as well.

The change of MAC PDU size can be indicated using a control PDU. The indication of change of the MAC PDU size, and/or the change of the MAC PDU size itself, can be event based or periodically updated.

The serving DU 595-1 may request for adjustment of scheduling grants based on its own buffer status, by sending a command to increase or decrease the size of the grant.

Flow control (currently between CU-UP 494 and DU 495) is needed between DU-DU here (i.e. between DU 595-1 and DU 595-2). This flow control is proposed to be done using a control PDU.

A similar approach can be followed for UL scheduling. The assisting DU 595-2 sends to the serving DU 595-1 (via CU-CP 596) over F1-C (598-1, 598-2), the MAC PDU sizes and allocated scheduling grants for UL reception. The change of MAC PDU size can be indicated by the assisting DU 595-2 using a control PDU. The serving DU 595-1 can also apply similar scheduling adjustment for uplink scheduling grants (by sending an up/down command) based on a BSR received from the UE 110. In MTRP-ICBM operation the BSR (buffer status report) is processed at the serving DU 595-1.

Regarding optimizations to avoid overhead and delays, with respect to the C-plane, all configurations/information are provided upfront during the mTRP setup itself to avoid any control plane signaling later. Any information that needs to be updated dynamically (e.g.: MAC PDU size, DL scheduling grant, etc.) are associated with an index and the serving/assisting DU (595-1, 595-2) can use a control PDU to signal the index. This avoids signaling the message over F1-U (598-3, 598-4). An additional DL scheduling grant can be requested by the serving DU 595-1, and an allocated DL scheduling grant can be modified by the assisting DU 595-2 (both dynamically as per the load/radio conditions), without C-plane signaling between DUs (595-1, 595-2) going via CU-CP 596.

Regarding optimizations to avoid overhead and delays, with respect to the U-Plane, implemented is transparent forwarding of a MAC-PDU of a UE in mTRP operation at the CU-UP 594 (no encoding/decoding). The assistance information (mTRP UE-ID and DL TEID) are shared with the CU-UP 594 to facilitate transparent forwarding.

As shown in FIG. 5, the serving DU's HARQ buffer 508 feeds data to both the serving cell TRP 595-1 and the assisting cell TRP 595-2. In particular, the HARQ buffer 508 feeds HARQ packet 1 514-1 to the serving cell TRP 595-1 with transmission 516, the HARQ buffer 508 feeds HARQ packet 2 514-2 to the serving cell TRP 595-1 with transmission 518, the HARQ buffer 508 feeds HARQ packet 514-3 to the assisting cell TRP 595-2 with transmission 520, and the HARQ buffer 508 feeds HARQ packet 4 514-4 to the assisting cell TRP 595-2 using transmission 522.

The serving DU 595-1 of the gNB 570 includes MAC-PS 502-1, and DU 595-2 of the gNB 570 includes MAC-PS 502-2. Cell 2 506 may be served by either DU 595-1 or DU 595-2. The serving DU 595-2 includes RLC buffer 510, where the RLC buffer 510 includes PDU1 512-1, PDU2 512-2, PDU3 512-3, and PDU4 512-4.

In FIG. 5, the serving cell 504 is associated with transmissions 516 and 518, and the assisting cell 509 is associated with F1-U 598-3, F1-U 598-4, and transmissions 520 and 522.

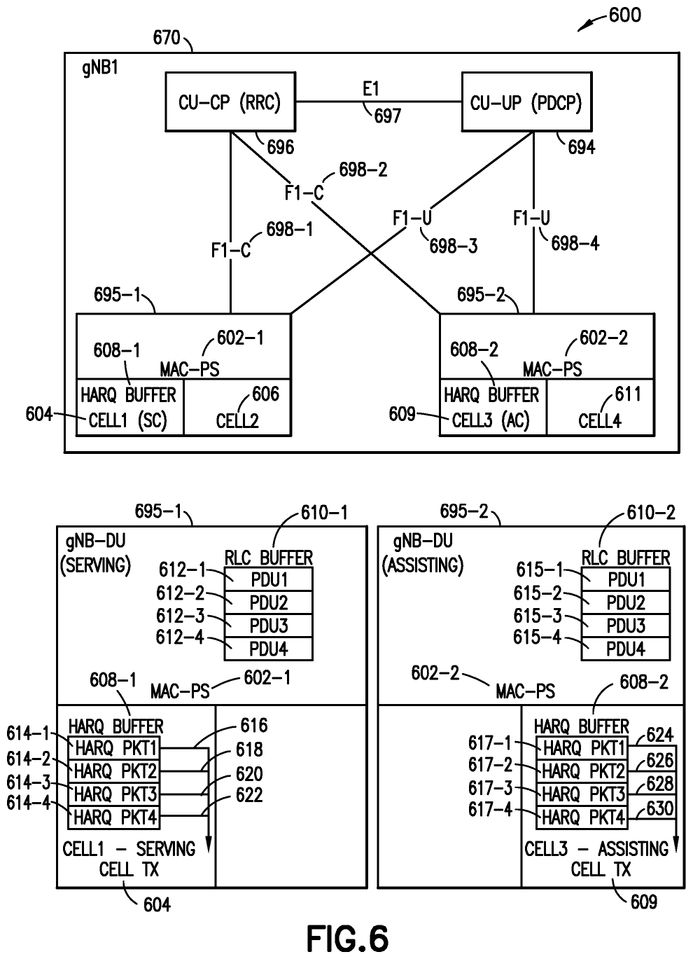

FIG. 6 is a diagram depicting an inter-DU mTRP second alternative 600, using NR-DC principles.

In the framework shown by FIG. 6, there is a dual F1-U link between the CU-UP 694 and serving, assisting DUs, i.e. two streams of data originating from the CU-UP 694, where the data split is performed at the CU-UP 694. In particular, there is an F1-U link 698-3 between the CU-UP 694 and the serving DU 695-1, and an F1-U link 698-4 between the CU-UP 694 and the assisting DU 695-2. There are separate RLC and HARQ buffers in each DU. In particular, the serving DU 695-1 includes RLC buffer 610-1 and HARQ buffer 608-1, and the assisting DU 695-2 includes RLC buffer 610-2 and HARQ buffer 608-2.

As further shown by FIG. 6, DL throughput share between serving cells (including serving cell 1 604) and assisting cells (including assisting cell 3 609) is decided by the CU-CP 696 and conveyed to the CU-UP 694. DL throughput share of the serving cells is depicted with Cell 1 (SC) 604, and HARQ packet transmissions (616, 618, 620, 622) from the HARQ buffer 608-1 of the serving cell TRP 695-1. DL throughput share of the assisting cells is depicted with cell 3 (AC) 609, HARQ packet transmissions (624, 626, 628, 630) from the HARQ buffer 608-2 of the assisting cell 3 TRP 695-2, F1-U link 698-3, and F1-U link 698-4. Dynamic change of share is implemented with signaling and re-configuration.

Scheduling is performed separately from the respective MAC-PS (602-1, 602-2). Only split bearer mTRP operation is possible at the CU-UP (PDCP) 694. The assisting cell configuration includes an RLC instance of the assisting DU 695-2. The mTRP is a lower layer operation and hence the serving DU may propose the data split ratio between serving and assisting cells. This is further communicated to the CU-CP and the CU-UP. The split between serving and assisting cell traffic from the CU-UP 694 is further adjusted based on flow control from each DU (695-1, 695-2). Further, there is co-ordination of the RLC instance configuration (of the serving DU 695-1) with the assisting DU 695-2 for mTRP split operation. For this, the CU-CP 696 procures the RLC config of the serving DU 695-1, and provides the RLC config to the assisting DU 695-2. This helps the assisting DU 695-2 to prepare a delta RLC config. The MTRP operation using switching of traffic at lower layers requires separate RLC instances at each DU. The serving DU 695-1 provides its current RLC configuration to allow the target DU to make use of the same or consider the current RLC configuration as a reference to create the delta configuration.

It is preferable to have a similar/same RLC config in both the serving 695-1 and assisting 695-2 DU since they are not different cell-groups (as in NR-DC).

Differences with NR-DC include i) no cell group concept as in NR-DC (MCG, SCG), ii) no master and secondary role, as there is only one cell group. Hence the RRC entity is also single. The assisting cell cannot be equated to the secondary node, as they are completely orthogonal to each other). A similar RLC configuration is preferred in serving and assisting DUs, iii) the serving DU determines the DL data split ratio unlike in NR-DC where the CU-CP determines the data split ratio.

As further shown in FIG. 6, the CU-CP 696 of the gNB 670 and the CU-UP 694 of the gNB 670 are coupled with an E1 link 697. An F1-C link 698-1 connects the CU-CP 696 to the DU 695-1, and an F1-C link 698-2 connects the CU-CP 696 to the DU 695-2. DU 695-1 further provides access to cell 2 606, and DU 695-2 further provides access to cell 4 611. The RLC buffer 610-1 of the serving DU 695-1 includes PDU1 612-1, PDU2 612-2, PDU3 612-3, and PDU4 612-4, and the RLC buffer 610-2 of the assisting DU 695-2 includes PDU1 615-1, PDU2 615-2, PDU3 615-3, and PDU4 615-4.

The HARQ buffer 608-1 transmits (616) HARQ packet 1 614-1 to the serving cell TRP 695-1, transmits (618) HARQ packet 2 614-2 to the serving cell TRP 695-1, transmits (620) HARQ packet 3 614-3 to the serving cell TRP 695-1, and transmits (622) HARQ packet 4 614-4 to the serving cell TRP 695-1. The HARQ buffer 608-2 transmits (624) HARQ packet 1 617-1 to the assisting cell TRP 695-2, transmits (626) HARQ packet 2 617-2 to the assisting cell TRP 695-2, transmits (628) HARQ packet 3 617-3 to the assisting cell TRP 695-2, and transmits (630) HARQ packet 4 617-4 to the assisting cell TRP 695-2.

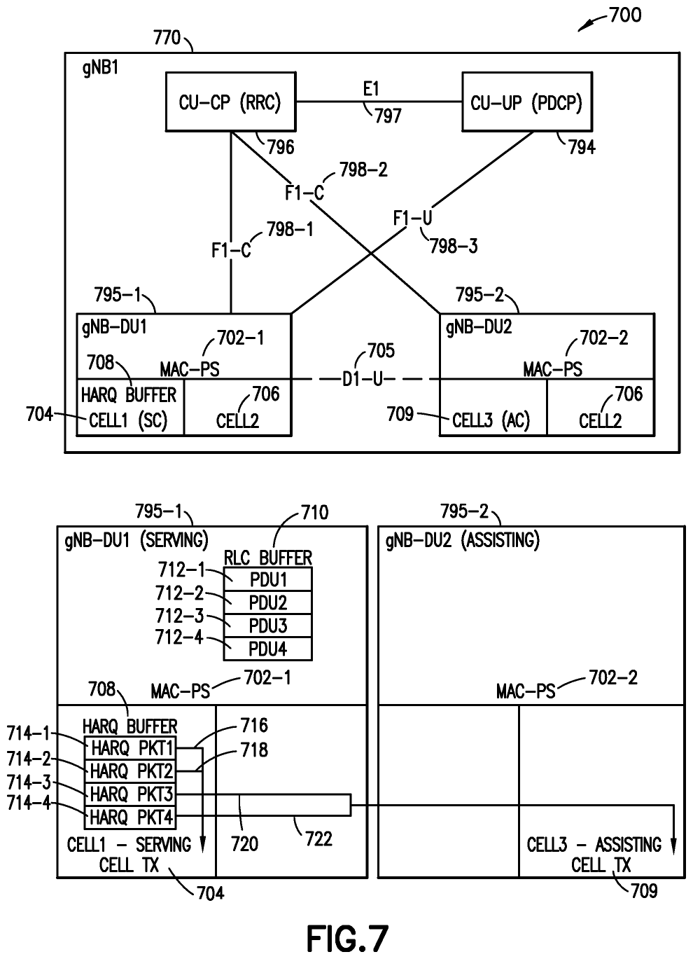

FIG. 7 is a diagram depicting an inter-DU mTRP third alternative 700, implementing a DU-DU direct interface.

In the framework shown by FIG. 7, there is a single F1-U link 798-3 between the CU-UP 794 and the serving DU 795-1 associated with mTRP operation, i.e. only one stream of DL data. The serving DU's HARQ buffer 708 is to feed data to both the serving cell TRP 795-1 and the assisting cell TRP 795-2. In particular, the HARQ buffer 708 transmits (716) HARQ packet 714-1 to the serving cell TRP 795-1, transmits (718) HARQ packet 714-2 to the serving cell TRP 795-1, transmits (720) HARQ packet 714-3 to the assisting cell TRP 795-2, and transmits (722) HARQ packet 714-4 to the assisting cell TRP 795-2. Thus, in the alternative shown by FIG. 7, data-split is performed from the single HARQ buffer 708.

Further in the alternative shown by FIG. 7, the CU-CP 796 performs only the assisting cell/DU selection and the serving DU 795-1 may prepare the assisting DU 795-2 for mTRP operation. There is a D1 interface, such as D1-U 705, between the serving DUs (e.g. 795-1) and the assisting DUs (e.g. 795-2). D1-C is used for preparation of mTRP configuration and allocation of DL scheduling grants. There is direct flow control between DUs (795-1, 795-2). There is also data forwarding at the RLC or MAC PDU level between source and target DUs (during a serving cell change). The remaining principles of alternative 3 700 are similar to alternative 1 500 as shown in FIG. 5.

As further shown in FIG. 7, the CU-CP 796 of the gNB 770 is connected to the CU-UP 794 with an E1 interface 797. The CU-CP 796 is connected to the DU 795-1 with F1-C interface 798-1, and the CU-CP 796 is connected to the DU 795-2 with the F1-C interface 798-2. The gNB-DU1 795-1 includes MAC-PS 702-1, and the gNB-DU2 795-2 includes MAC-PS 702-2. Both DU 795-1 and DU 795-2 serve cell2 706. The serving gnB-DU1 795-1 includes RLC buffer 710, where the RLC buffer 710 includes PDU1 712-1, PDU2 712-2, PDU3 712-3, and PDU4 712-4.

In FIG. 7, the serving cell 704 is associated with transmissions 716 and 718, and the assisting cell 509 is associated with F1-U 798-3, D1-U 705, and transmissions 720 and 722.

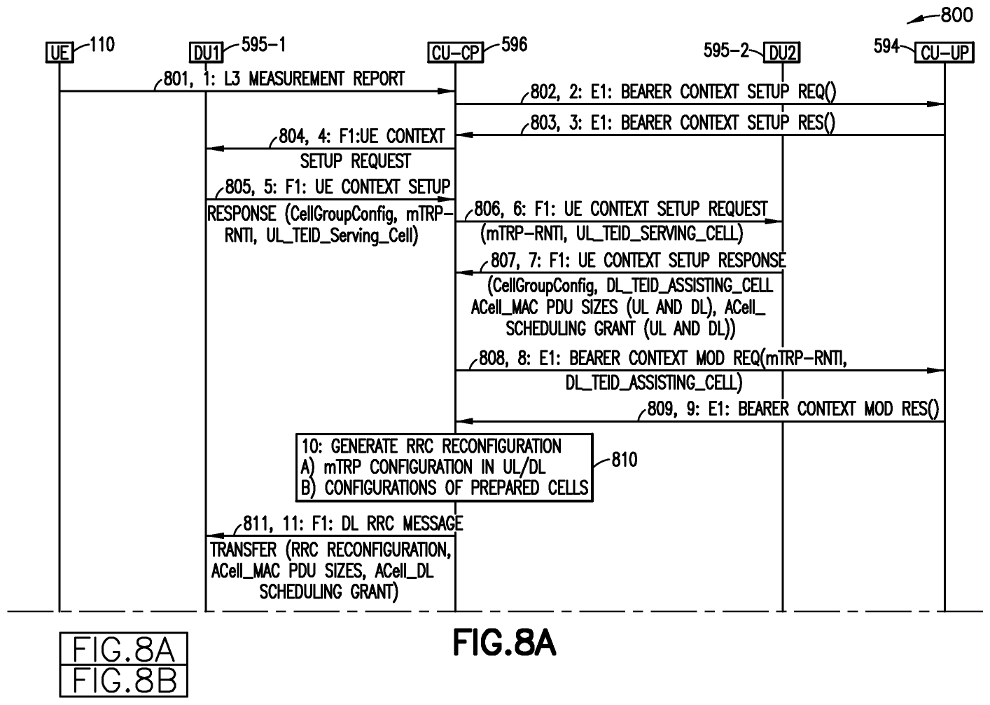

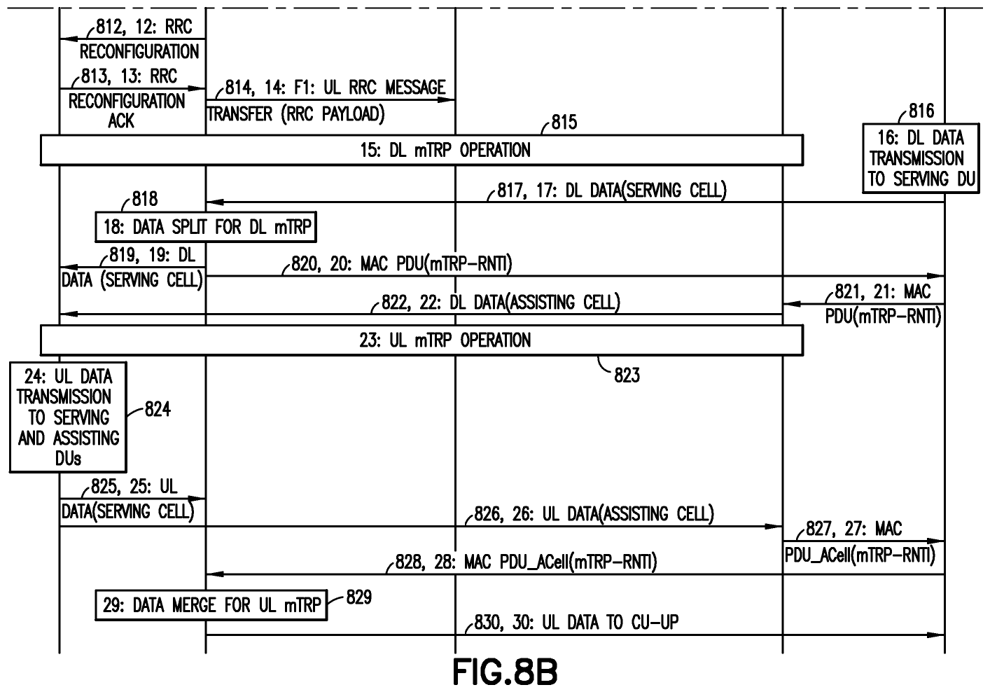

FIG. 8 is a signaling diagram of a process flow 800 implementing the inter-DU mTRP first alternative 500 shown in FIG. 5. At 801, the UE 110 transmits an L3 measurement report to the CU-CP 596. At 802, the CU-CP 596 transmits an E1 bearer context setup request to the CU-UP 594. At 803, the CU-UP 594 transmits an E1 bearer context setup response to the CU-CP 596. At 804, the CU-CP 596 transmits an F1 UE context setup request message to the DU1 595-1. At 805, the DU1 595-1 transmits an F1 UE context setup response message to the CU-CP 596. The F1 UE context setup response message transmitted at 805 includes a cell group configuration, an mTRP-RNTI and a serving cell UL TEID. At 806, the CU-CP 596 transmits an F1 UE context setup request to the DU2 595-2, where the F1 UE context setup request includes the mTRP-RNTI and the serving cell UL TEID. At 807, the DU2 595-2 transmits an F1 UE context setup response message to the CU-CP 596, where the F1 UE context setup response message includes a cell group configuration, an assisting cell DL TEID, an assisting cell UL TEID, assisting cell MAC PDU sizes for uplink and downlink, and an assisting cell scheduling grant for uplink and downlink. At 808, the CU-CP 596 transmits an E1 bearer context modification request to the CU-UP 594, where the E1 bearer context modification request includes the mTRP-RNTI, the assisting cell DL TEID, and the assisting cell UL TEID. At 809, the CU-UP 594 transmits an E1 bearer context modification response message to the CU-CP 596. At 810, the CU-CP 596 generates an RRC reconfiguration, where the RRC reconfiguration includes an mTRP configuration in UL/DL, and configurations of prepared cells.

At 811, the CU-CP 596 transmits to the DU1 595-1 an F1 DL RRC message transfer, where the F1 DL RRC message transfer includes an RRC reconfiguration, the assisting cell MAC PDU sizes, and the assisting cell downlink scheduling grant. At 812, the DU1 595-1 transmits an RRC reconfiguration to the UE 110. The RRC message at 812 is originated at the CU-CP 596, and is carried as a payload over F1 DL RRC message transfer and transmitted over the air interface. The additional IEs along with the RRC payload are for consumption by the serving DU 595-1. At 813, the UE 110 transmits an RRC reconfiguration acknowledgement to the DU1 595-1. At 814, the DU1 595-1 transmits an F1 UL RRC message transfer message, including the RRC payload, to the CU-CP 596. At 815, the UE 110, the DU1 595-1, the CU-CP 596, and the DU2 595-2 perform DL mTRP operation. At 816, the CU-UP 594 transmits downlink data to the serving DU 595-1. At 817, the CU-UP 594 transmits serving cell downlink data to the DU1 595-1. At 818, the DU1 595-1 performs data split for DL mTRP. At 819, the DU1 595-1 transmits serving cell DL data to the UE 110. At 820, the DU1 595-1 transmits a MAC PDU to the CU-UP 594, where the MAC PDU includes the mTRP-RNTI.

At 821, the CU-UP 594 transmits a MAC PDU to the DU2 595-2, where the MAC PDU includes the mTRP-RNTI. At 822, the DU2 595-2 transmits assisting cell DL data to the UE 110. At 823, the UE 110, the DU1 595-1, the CU-CP 596, and the DU2 595-2 perform UL mTRP operation. At 824, the UE 110 performs UL data transmission to serving and assisting DUs (e.g. to DU1 595-1 and DU2 595-2). At 825, the UE 110 transmits UL serving cell data to the DU1 595-1. At 826, the UE 110 transmits UL assisting cell data to the DU2 595-2. At 827, the DU2 595-2 transmits an assisting cell MAC PDU to the CU-UP 594, where the assisting cell MAC PDU includes the mTRP-RNTI. At 828, the CU-UP 594 transmits the assisting cell MAC PDU to the DU1 595-1, where the assisting cell MAC PDU includes the mTRP-RNTI. At 829, the DU1 595-1 performs data merging for UL mTRP. At 830, the DU1 595-1 transmits uplink data to the CU-UP 594.

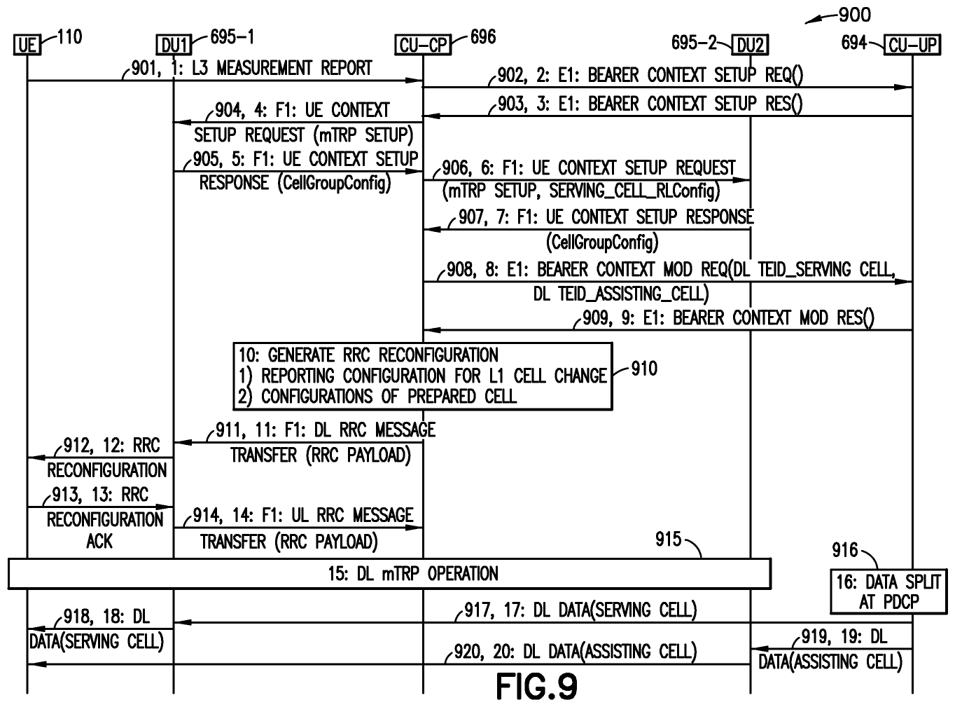

FIG. 9 is a signaling diagram of a process flow 900 implementing the inter-DU mTRP second alternative 600 shown in FIG. 6. At 901, the UE 110 transmits an L3 measurement report to the CU-CP 696. At 902, the CU-CP 696 transmits an E1 bearer context setup request to the CU-UP 694. At 903, the CU-UP 694 transmits an E1 bearer context setup response to the CU-CP 696. At 904, the CU-CP 696 transmits an F1 UE context setup request to the DU1 695-1, where the F1 UE context setup request includes mTRP setup. At 905, the DU1 695-1 transmits an F1 UE context setup response message to the CU-CP 696. The F1 UE context setup response message transmitted at 905 includes a cell group configuration. At 906, the CU-CP 696 transmits an F1 UE context setup request to the DU2 695-2, where the F1 UE context setup request includes the mTRP setup and a serving cell RLC configuration. At 907, the DU2 695-2 transmits an F1 UE context setup response message to the CU-CP 696, where the F1 UE context setup response message includes a cell group configuration. At 908, the CU-CP 696 transmits an E1 bearer context modification request to the CU-UP 694, where the E1 bearer context modification request includes a serving cell DL TEID, and an assisting cell DL TEID. At 909, the CU-UP 694 transmits an E1 bearer context modification response message to the CU-CP 696. At 910, the CU-CP 696 generates an RRC reconfiguration, including 1) reporting the configuration for L1 cell change, and 2) generating configurations of a prepared cell.

At 911, the CU-CP 696 transmits to the DU1 695-1 an F1 DL RRC message transfer, where the F1 DL RRC message transfer includes an RRC payload. At 912, the DU1 695-1 transmits an RRC reconfiguration to the UE 110. At 913, the UE 110 transmits an RRC reconfiguration acknowledgement to the DU1 695-1. At 914, the DU1 695-1 transmits an F1 UL RRC message transfer message, including the RRC payload, to the CU-CP 696. At 915, the UE 110, the DU1 695-1, the CU-CP 696, and the DU2 695-2 perform DL mTRP operation. At 916, the CU-UP 694 performs data split at PDCP. At 917, the CU-UP 694 transmits serving cell downlink data to the DU1 695-1. At 918, the DU1 695-1 transmits serving cell downlink data to the UE 110. At 919, the CU-UP 694 transmits assisting cell downlink data to the DU2 695-2.

At 920, the DU2 695-2 transmits assisting cell downlink data to the UE 110.

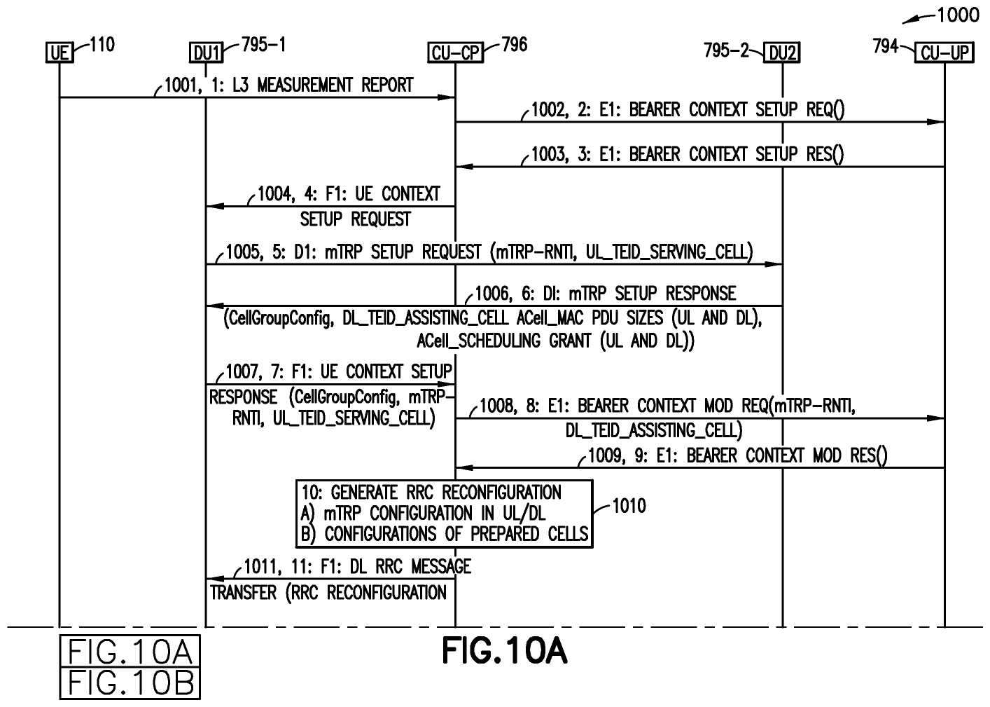

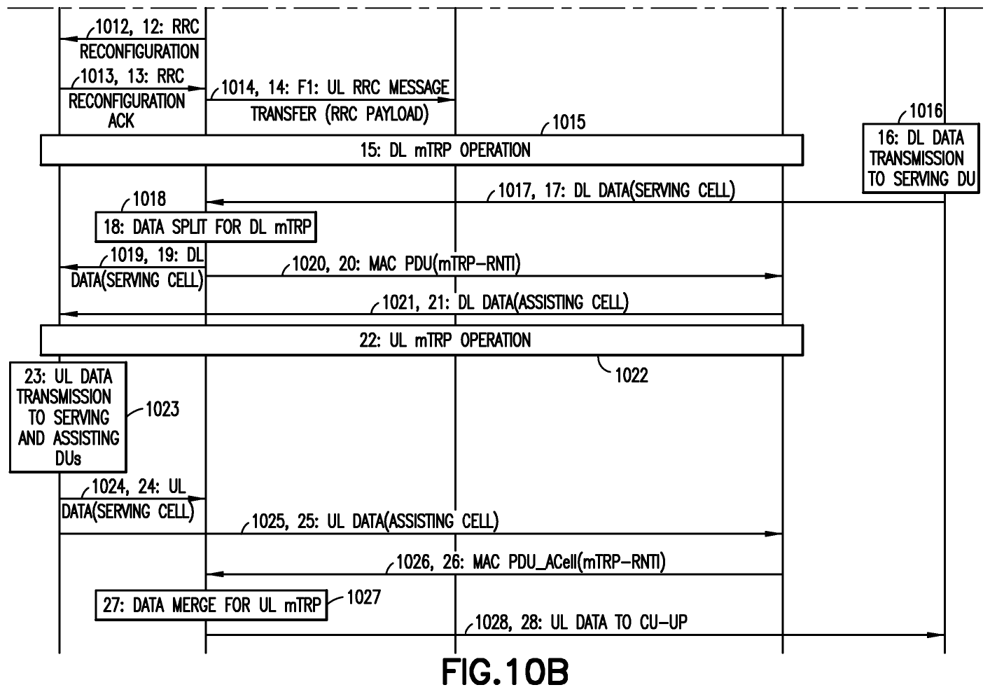

FIG. 10 is a signaling diagram of a process flow 1000 implementing the inter-DU mTRP third alternative 700 shown in FIG. 7. At 1001, the UE 110 transmits an L3 measurement report to the CU-CP 796. At 1002, the CU-CP 796 transmits an E1 bearer context setup request to the CU-UP 794. At 1003, the CU-UP 794 transmits an E1 bearer context setup response to the CU-CP 796. At 1004, the CU-CP 796 transmits an F1 UE context setup request message to the DU1 795-1. At 1005, the DU1 795-1 transmits a D1 mTRP setup request to DU2 795-2, where the D1 mTRP setup request includes an mTRP-RNTI and a serving cell UL TEID. At 1006, the DU2 795-2 transmits a D1 mTRP setup response message to DU1 795-1, where the mTRP setup response message includes a cell group configuration, an assisting cell DL TEID, assisting cell MAC PDU sizes (UL and DL), an assisting cell scheduling grant for uplink, and an assisting cell scheduling grant for downlink. At 1007, the DU1 795-1 transmits an F1 UE context setup response message to the CU-CP 796, where the F1 UE context setup response message includes a cell group configuration, the mTRP-RNTI, and the serving cell UL TEID. At 1008, the CU-CP 796 transmits an E1 bearer context modification request to the CU-UP 794, where the E1 bearer context modification request includes the mTRP-RNTI, and the assisting cell DL TEID. At 1009, the CU-UP 794 transmits an E1 bearer context modification response message to the CU-CP 796. At 1010, the CU-CP 796 generates an RRC reconfiguration, the where RRC reconfiguration includes an mTRP configuration in UL/DL, and configurations of prepared cells.

At 1011, the CU-CP 796 transmits to the DU1 795-1 an F1 DL RRC message transfer, where the F1 DL RRC message transfer includes an RRC reconfiguration. At 1012, the DU1 795-1 transmits the RRC reconfiguration to the UE 110. At 1013, the UE 110 transmits an RRC reconfiguration acknowledgement to the DU1 795-1. At 1014, the DU1 795-1 transmits an F1 UL RRC message transfer message, including the RRC payload, to the CU-CP 796. At 1015, the UE 110, the DU1 795-1, the CU-CP 796, and the DU2 795-2 perform DL mTRP operation. At 1016, the CU-UP 794 transmits downlink data to the serving DU 795-1. At 1017, the CU-UP 794 transmits serving cell downlink data to the DU1 795-1. At 1018, the DU1 795-1 performs data split for DL mTRP. At 1019, the DU1 795-1 transmits serving cell DL data to the UE 110. At 1020, the DU1 795-1 transmits a MAC PDU to the DU2 795-2, where the MAC PDU includes an mTRP-RNTI.

At 1021, the DU2 795-2 transmits assisting cell downlink data to the UE 110. At 1022, the UE 110, the DU1 795-1, the CU-CP 796, and the DU2 795-2 perform UL mTRP operation. At 1023, the UE 110 performs UL data transmission to serving and assisting DUs (e.g. to DU1 795-1 and DU2 795-2). At 1024, the UE 110 transmits UL serving cell data to the DU1 795-1. At 1025, the UE 110 transmits UL assisting cell data to the DU2 795-2. At 1026, the DU2 795-2 transmits an assisting cell MAC PDU to the DU1 795-1, where the assisting cell MAC PDU includes the mTRP-RNTI. At 1027, the DU1 795-1 performs data merging for UL mTRP. At 1028, the DU1 795-1 transmits uplink data to the CU-UP 794.

In some examples described herein, a control plane node refers to the CU-CP (e.g. 596, 696, 796), a user plane node refers to the CU-UP (e.g. 594, 694, 794), a serving distributed node refers to a DU (e.g. 595-1, 695-1, 795-1), and an assisting distributed node refers to a DU (e.g. 595-2, 695-2, 795-2).

There are several advantages, improvements, and technical effects of the examples described herein. In particular, the examples described herein provide three different implementations/solutions for the problem described above with different advantages for each.

For example for solution 1 500, the configurations and information are provided up front during the mTRP setup itself to avoid any control plane signaling later. Any information that needs to be updated dynamically (e.g.: MAC PDU size, DL scheduling grant etc.) is associated with an index and the serving/assisting DU can use a control PDU to signal the index. This avoids a signaling message over F1-U.

The examples described herein may be the basis for changes to the 3GPP standards in NR. In particular, the proposed methods may be standardized in TS 38.300 (stage 2 description), TS 38.421, 38.463 (E1) and TS 38.473 (F1 specification).

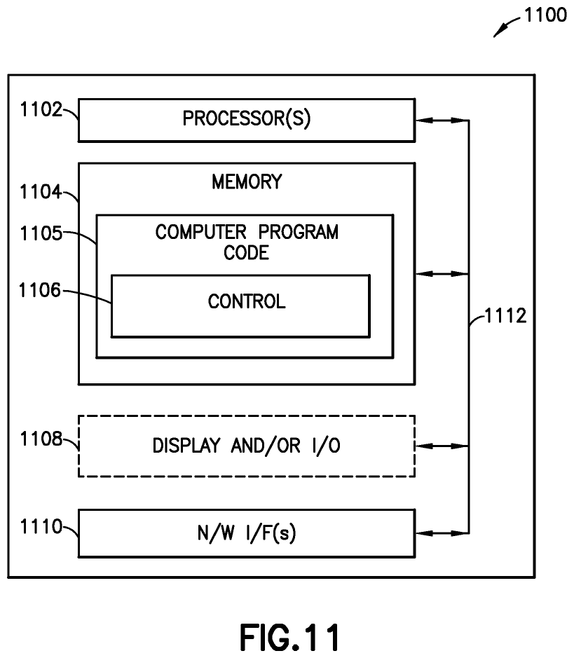

FIG. 11 is an example apparatus 1100, which may be implemented in hardware, configured to implement the examples described herein. The apparatus 1100 comprises at least one processor 1102 (e.g., an FPGA and/or CPU), at least one memory 1104 including computer program code 1105, wherein at the least one memory 604 and the computer program code 1105 are configured to, with at least one processor 1102, cause the apparatus 1100 to implement circuitry, a process, component, module, or function (collectively control 1106) to implement the examples described herein, including inter-DU multi-TRP operation.

The apparatus 1100 optionally includes a display and/or I/O interface 1108 that may be used to display aspects or a status of the methods described herein (e.g., as one of the methods is being performed or at a subsequent time), or to receive input from a user such as with using a keypad or touchscreen. The apparatus 1100 includes one or more network (N/W) interfaces (I/F(s)) 1110. The N/W I/F(s) 1110 may be wired and/or wireless and communicate over the Internet/other network(s) via any communication technique. The N/W I/F(s) 1110 may comprise one or more transmitters and one or more receivers. The N/W I/F(s) 1110 may comprise standard well-known components such as an amplifier, filter, frequency-converter, (de) modulator, and encoder/decoder circuitries and one or more antennas.

The apparatus 1100 to implement the functionality of control 1106 may be the UE (110), RAN node 170, network element(s) 190, or any of the other items depicted in FIGS. 5-10 such as the UE, serving DU, assisting DU, CU-CP, or the CU-UP. Apparatus 1100 may be part of a self-organizing/optimizing network (SON) node, such as in a cloud. The apparatus 1100 may also be distributed throughout the network 100 including within and between apparatus 1100 and any network element (such as a network control element (NCE) 190 and/or the RAN node 170 and/or the UE 110) including the network elements depicted in FIGS. 5-10.

Interface 1112 enables data communication between the various items of apparatus 1100, as shown in FIG. 11. For example, the interface 1112 may be one or more buses such as address, data, or control buses, and may include any interconnection mechanism, such as a series of lines on a motherboard or integrated circuit, fiber optics or other optical communication equipment, and the like. Computer program code 1105, including control 1106 may comprise object-oriented software configured to pass data/messages between objects within computer program code 1105. The apparatus 1100 need not comprise each of the features mentioned, or may comprise other features as well.

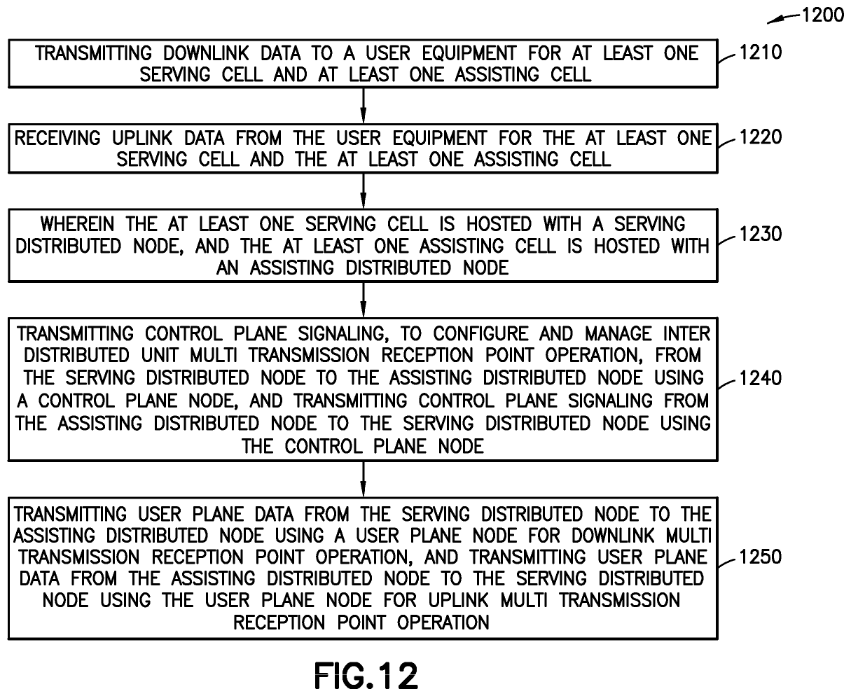

FIG. 12 is an example method 1200 to implement the example embodiments described herein. At 1210, the method includes transmitting downlink data to a user equipment for at least one serving cell and at least one assisting cell. At 1220, the method includes receiving uplink data from the user equipment for the at least one serving cell and the at least one assisting cell. At 1230, the method includes wherein the at least one serving cell is hosted with a serving distributed node, and the at least one assisting cell is hosted with an assisting distributed node. At 1240, the method includes transmitting control plane signaling, to configure and manage inter distributed unit multi transmission reception point operation, from the serving distributed node to the assisting distributed node using a control plane node, and transmitting control plane signaling from the assisting distributed node to the serving distributed node using the control plane node. At 1250, the method includes transmitting user plane data from the serving distributed node to the assisting distributed node using a user plane node for downlink multi transmission reception point operation, and transmitting user plane data from the assisting distributed node to the serving distributed node using the user plane node for uplink multi transmission reception point operation. Method 1200 may be performed with a network node, for example a gNB implementing alternative one described herein.

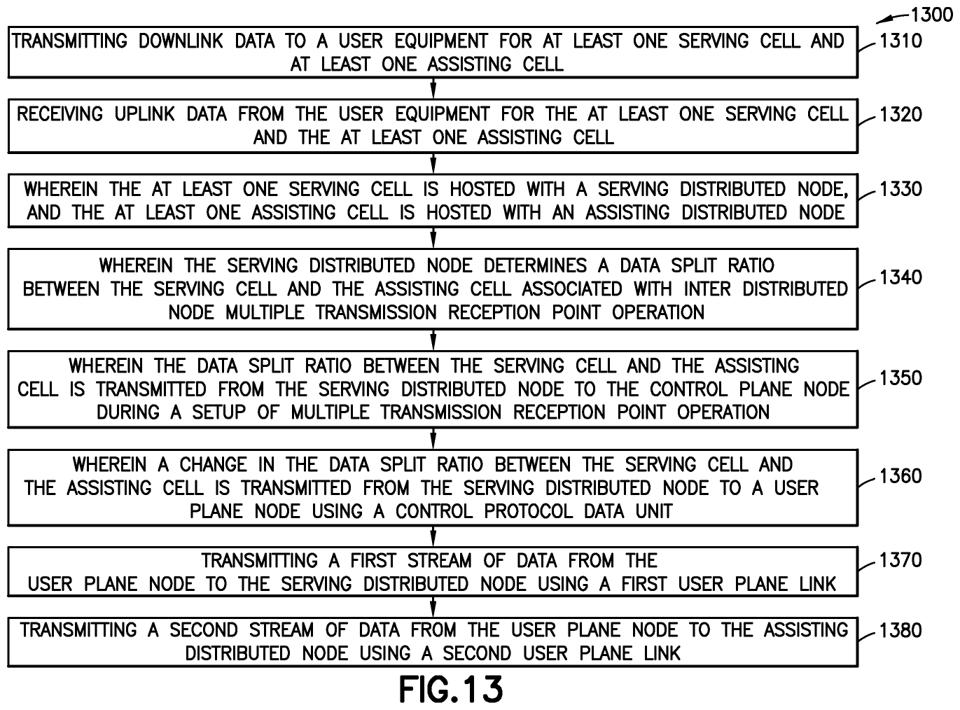

FIG. 13 is an example method 1300 to implement the example embodiments described herein. At 1310, the method includes transmitting downlink data to a user equipment for at least one serving cell and at least one assisting cell. At 1320, the method includes receiving uplink data from the user equipment for the at least one serving cell and the at least one assisting cell. At 1330, the method includes wherein the at least one serving cell is hosted with a serving distributed node, and the at least one assisting cell is hosted with an assisting distributed node. At 1340, the method includes wherein the serving distributed node determines a data split ratio between the serving cell and the assisting cell associated with inter distributed node multiple transmission reception point operation. At 1350, the method includes wherein the data split ratio between the serving cell and the assisting cell is transmitted from the serving distributed node to the control plane node during a setup of multiple transmission reception point operation. At 1360, the method includes wherein a change in the data split ratio between the serving cell and the assisting cell is transmitted from serving distributed node to the user plane node using a control protocol data unit. At 1370, the method includes transmitting a first stream of data from a user plane node to the serving distributed node using a first user plane link. At 1380, the method includes transmitting a second stream of data from the user plane node to the assisting distributed node using a second user plane link. Method 1300 may be performed with a network node. Method 1300 may be performed with a network node, for example a gNB implementing alternative two described herein.

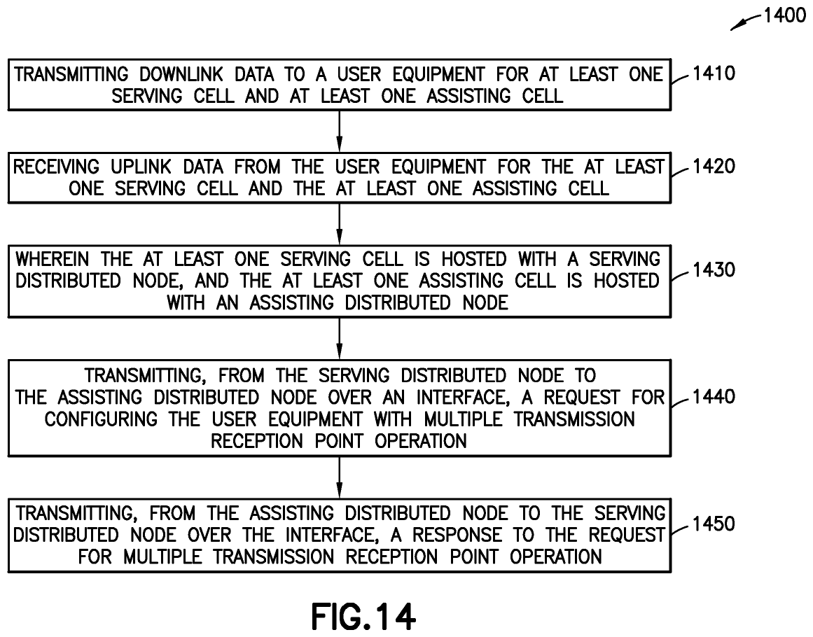

FIG. 14 is an example method 1400 to implement the example embodiments described herein. At 1410, the method includes transmitting downlink data to a user equipment for at least one serving cell and at least one assisting cell. At 1420, the method includes receiving uplink data from the user equipment for the at least one serving cell and the at least one assisting cell. At 1430, the method includes wherein the at least one serving cell is hosted with a serving distributed node, and the at least one assisting cell is hosted with an assisting distributed node. At 1440, the method includes transmitting, from the serving distributed node to the assisting distributed node over an interface, a request for configuring the user equipment with multiple transmission reception point operation. At 1450, the method includes transmitting, from the assisting distributed node to the serving distributed node over the interface, a response to the request for multiple transmission reception point operation. Method 1400 may be performed with a network node, for example a gNB implementing alternative three described herein.

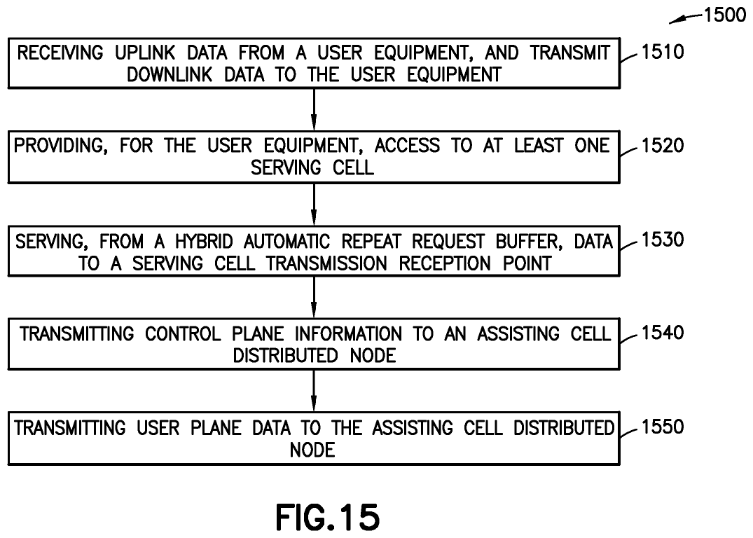

FIG. 15 is an example method 1500 to implement the example embodiments described herein. At 1510, the method includes receiving uplink data from a user equipment, and transmit downlink data to the user equipment. At 1520, the method includes providing, for the user equipment, access to at least one serving cell. At 1530, the method includes serving, from a hybrid automatic repeat request buffer, data to a serving cell transmission reception point. At 1540, the method includes transmitting control plane information to an assisting cell distributed node. At 1550, the method includes transmitting user plane data to the assisting cell distributed node. Method 1500 may be performed with a network node, for example a serving distributed node.

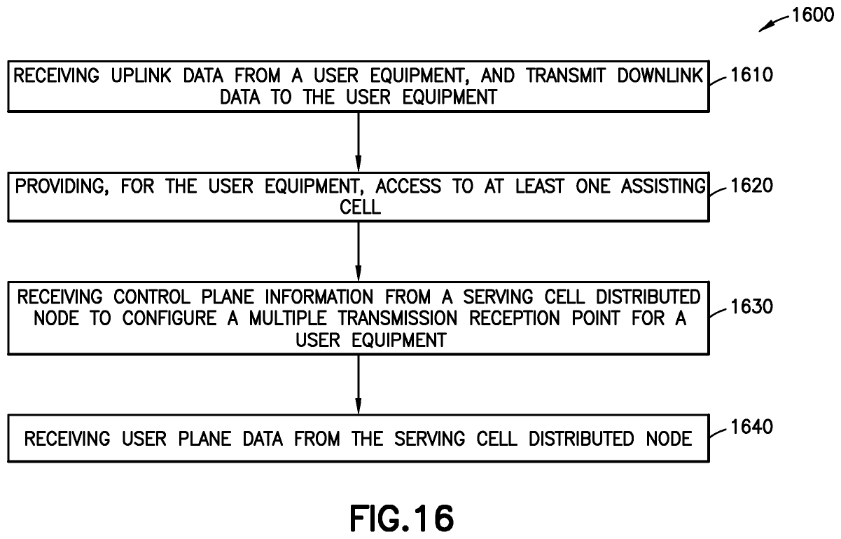

FIG. 16 is an example method 1600 to implement the example embodiments described herein. At 1610, the method includes receiving uplink data from a user equipment, and transmit downlink data to the user equipment. At 1620, the method includes providing, for the user equipment, access to at least one assisting cell. At 1630, the method includes receiving control plane information from a serving cell distributed node to configure multiple transmission reception point for a user equipment. At 1640, the method includes receiving user plane data from the serving cell distributed node. Method 1600 may be performed with a network node, for example an assisting distributed node.

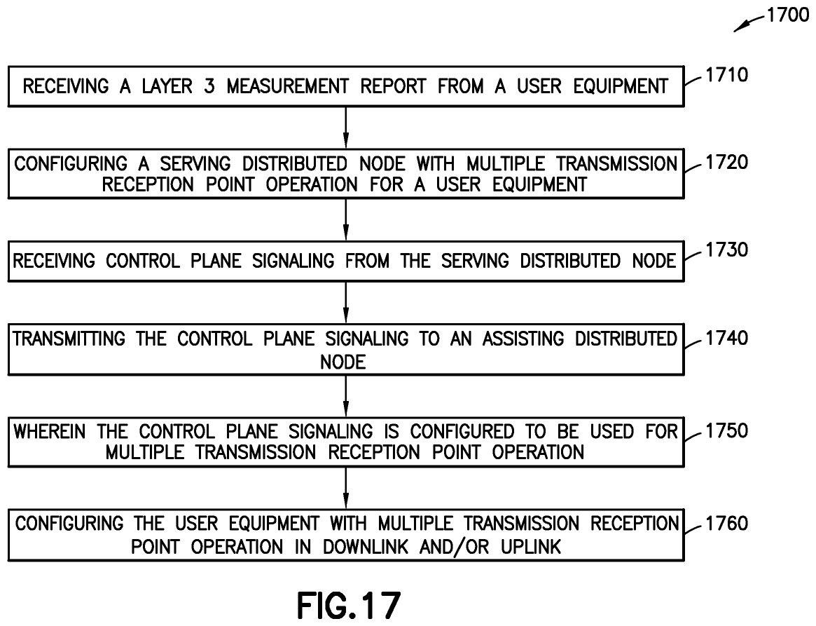

FIG. 17 is an example method 1700 to implement the example embodiments described herein. At 1710, the method includes receiving a layer 3 measurement report from a user equipment. At 1720, the method includes configuring a serving distributed node with multiple transmission reception point operation for a user equipment. At 1730, the method includes receiving control plane signaling from the serving distributed node. At 1740, the method includes transmitting the control plane signaling to an assisting distributed node. At 1750, the method includes wherein the control plane signaling is configured to be used for multiple transmission reception point operation. At 1760, the method includes configuring the user equipment with multiple transmission reception point operation in downlink and/or uplink. Method 1700 may be performed with a network node, for example a control plane node.

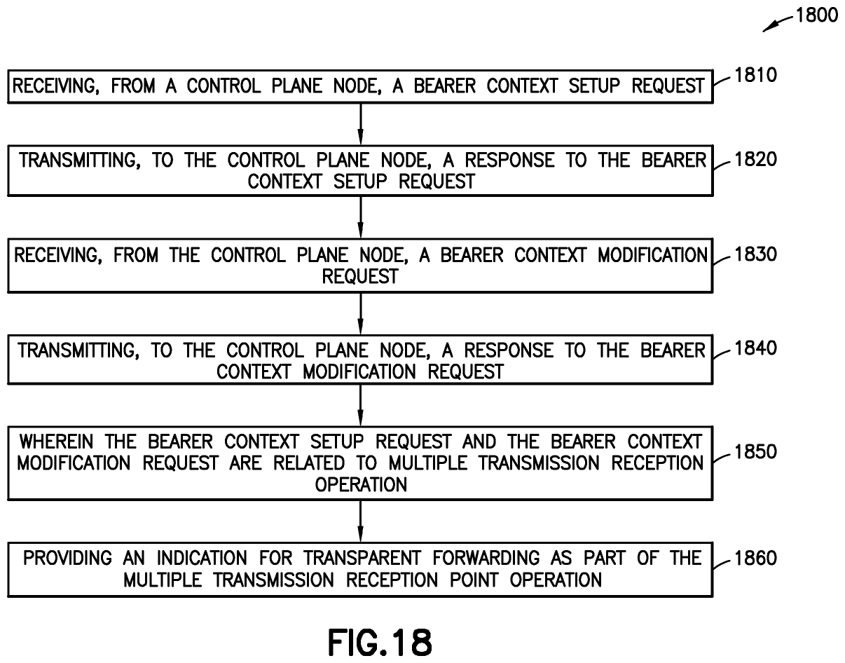

FIG. 18 is an example method 1800 to implement the example embodiments described herein. At 1810, the method includes receiving, from a control plane node, a bearer context setup request. At 1820, the method includes transmitting, to the control plane node, a response to the bearer context setup request. At 1830, the method includes receiving, from the control plane node, a bearer context modification request. At 1840, the method includes transmitting, to the control plane node, a response to the bearer context modification request. At 1850, the method includes wherein the bearer context setup request and the bearer context modification request are related to multiple transmission reception operation. At 1860, the method includes providing an indication for transparent forwarding as part of the multiple transmission reception point operation. Method 1700 may be performed with a network node, for example a user plane node.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory (ies) (including memory 1104) as described herein may be implemented using any suitable data storage technology, such as semiconductor based memory devices, flash memory, magnetic memory devices and systems, optical memory devices and systems, non-transitory memory, transitory memory, volatile memory, non-volatile memory, fixed memory and removable memory. The memory (ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, cellular network device, or another network device.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021-06) section 3.2 incorporated by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1 incorporated by reference.

Different functional splits between the central and distributed unit are possible, e.g. called options:

### Option 1 (1A-Like Split)

The function split in this option is similar to the 1A architecture in DC. RRC is in the central unit. PDCP, RLC, MAC, physical layer and RF are in the distributed unit.

### Option 2 (3C-Like Split)

The function split in this option is similar to the 3C architecture in DC. RRC and PDCP are in the central unit. RLC, MAC, physical layer and RF are in the distributed unit.

### Option 3 (Intra RLC Split)

-Low RLC (partial function of RLC), MAC, physical layer and RF are in the distributed unit. PDCP and high RLC (the other partial function of RLC) are in the central unit.

### Option 4 (RLC-MAC Split)

MAC, physical layer and RF are in the distributed unit. PDCP and RLC are in the central unit.

Or else, e.g. according to 3GPP TR 38.801 V14.0.0 (2017-03) section 11 incorporated by reference.

A gNB supports different protocol layers, e.g.

Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and segm. to segmentation;
Control channels include (BCCH, PCCH).

Layer 3 (L3) includes e.g. Radio Resource Control (RRC), e.g. according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

Multicast operation (also including bi-casting operation (original+copy/duplicate)):

In downlink multicast operation comprises: transmitting a message from at least two different cells to a single user equipment (UE), e.g. transmitting a message, e.g. RRC message or RRC PDU (Packet Data Unit), from a first, serving cell to a UE and transmitting a copy or duplicate of the message or at least its payload, e.g. RRC payload or RRC SDU (Service Data Unit), from an assisting cell to the UE. This way the UE receives the “same” message via at least two different radio links, e.g. at least twice. If one radio link is disturbed, the message is received at least once. The message and its duplicate are preferably transmitted simultaneously or shortly one after the other, e.g. within milliseconds. The message may be a control plane signaling message, e.g. RRC message comprising RRC payload, or a user plane message comprising data. A message may include a header and payload, and potentially a footer.

In uplink multicast operation comprises: transmitting a message from a single user equipment (UE) to at least two different cells, e.g. transmitting a message, e.g. Acknowledgement (ACK) message, from the UE to a first, serving cell and/or transmitting a copy or duplicate of the message or at least its content from the UE to an assisting cell. The message and its duplicate are preferably transmitted simultaneously or shortly one after the other, e.g. within milliseconds. The message may be a control plane signaling message, e.g. ACK message, or a user plane message comprising data.

With respect to the description herein, multicast may be called duplicate operation, as multicast is typically point-to-multipoint, while as described herein there are two unicast messages travelling via different radio links, one original and a copy/duplicate thereof (at least payload), however as used herein this concept is also referred to as multicast.

The following examples 1-76 are provided herein among the described examples. The features of the dependent device claims/examples could also be added to the method claims/examples.

Example 1: An apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; transmit control plane signaling, to configure and manage inter distributed unit multi transmission reception point operation, from the serving distributed node to the assisting distributed node using a control plane node, and transmit control plane signaling from the assisting distributed node to the serving distributed node using the control plane node; and transmit user plane data from the serving distributed node to the assisting distributed node using a user plane node for downlink multi transmission reception point operation, and transmit user plane data from the assisting distributed node to the serving distributed node using the user plane node for uplink multi transmission reception point operation.

Example 2: The apparatus of example 1, wherein the distributed node supports distributed unit and/or layer 2 functionality.

Example 3: The apparatus of any one of examples 1 to 2, wherein the control plane node supports central unit and/or layer 3 functionality.

Example 4: The apparatus of any one of examples 1 to 3, wherein the serving distributed node facilitates a radio link control buffer and a hybrid automatic repeat request buffer, where the hybrid automatic repeat request buffer is used for the inter distributed unit multi transmission reception point operation.

Example 5: The apparatus of example 4, wherein the hybrid automatic repeat request buffer serves data to the serving distributed node and to the assisting distributed node.

Example 6: The apparatus of any one of examples 1 to 5, wherein buffers of the serving distributed node are used to provide a hybrid automatic repeat request protocol data unit to the assisting distributed node.

Example 7: The apparatus of any one of examples 1 to 6, comprising a data transmission link between the serving distributed node and the user plane node.

Example 8: The apparatus of any one of examples 1 to 7, wherein the at least one memory and the computer program code are further configured to, with the at least one processor, cause the apparatus at least to: assign, with the serving distributed node, a multiple transmission reception point radio network temporary identifier to uniquely identify the user equipment associated with multiple transmission reception point operation; transmit, from the serving distributed node, the multiple transmission reception point radio network temporary identifier to the control plane node; transmit, from the control plane node, the multiple transmission and reception point radio network temporary identifier to the user plane node and the assisting distributed node; wherein the multiple transmission reception point radio network temporary identifier is configured to be used with the user plane node to identify medium access control protocol data units of the user equipment in multiple transmission reception point operation.

Example 9: The apparatus of any one of examples 1 to 8, wherein the at least one memory and the computer program code are further configured to, with the at least one processor, cause the apparatus at least to: allocate, with the control plane node, a multiple transmission reception point radio network temporary identifier to uniquely identify the user equipment associated with multiple transmission reception point operation; and transmit, from the control plane node, the multiple transmission reception point radio network temporary identifier to the serving distributed node; wherein the multiple transmission reception point radio network temporary identifier is configured to be used with the serving distributed node to configure multiple transmission reception for the user equipment and to identify medium access control protocol data units of the user equipment in multiple transmission reception point operation.

Example 10: The apparatus of any one of examples 1 to 9, wherein the at least one memory and the computer program code are further configured to, with the at least one processor, cause the apparatus at least to: transmit, from the control plane node to the user plane node, a downlink tunnel endpoint identifier of the assisting distributed node, and a multiple transmission reception point radio network temporary identifier; wherein the downlink tunnel endpoint identifier of the assisting distributed node is configured to be used with the user plane node to transparently transmit a medium access control protocol data unit received from the serving distributed node to the assisting distributed node.

Example 11: The apparatus of any one of examples 1 to 10, wherein the at least one memory and the computer program code are further configured to, with the at least one processor, cause the apparatus at least to: form, with the serving distributed node, a multiple transmission reception point medium access control protocol data unit using a medium access control protocol data unit and a header, wherein a hybrid automatic repeat request protocol data unit is embedded within the medium access control protocol data unit.

Example 12: The apparatus of any one of examples 1 to 11, wherein: the user plane data transmitted from the serving distributed node to the assisting distributed node comprises a medium access control protocol data unit associated with downlink data; and the user plane data transmitted from the assisting distributed node to the serving distributed node comprises a medium access control protocol data unit associated with uplink data.

Example 13: The apparatus of any one of examples 1 to 12, wherein the at least one memory and the computer program code are further configured to, with the at least one processor, cause the apparatus at least to: receive, at the control plane node, an uplink tunnel endpoint identifier associated with the uplink multiple transmission reception point operation, from the serving distributed node; transmit, from the control plane node, the uplink tunnel endpoint identifier to the assisting distributed node and the user plane node; form, with the assisting distributed node, a medium access control protocol data unit, in response to receiving a hybrid automatic repeat request protocol data unit from the user equipment; wherein the medium access control protocol data unit is formed with attaching a header to the hybrid automatic repeat request protocol data unit, where the header includes a multiple transmission reception point radio network temporary identifier received from the control plane node to assist the user plane node to determine that the hybrid automatic repeat request protocol data unit is for multiple transmission reception point user equipment data; transparently forward, from the user plane node to the serving distributed node, the formed medium access control protocol data unit; and transmit, from the serving distributed node, merged uplink data to the user plane node, where the merged uplink data comprises at least one serving and assisting uplink medium access control protocol data unit.

Example 14: The apparatus of any one of examples 1 to 13, wherein the at least one memory and the computer program code are further configured to, with the at least one processor, cause the apparatus at least to: transmit, from the assisting distributed node to the control plane node over a first control interface, at least one medium access control protocol data unit size and an allocated scheduling grant; and transmit, from the control plane node to the serving distributed node over a second control interface, the at least one medium access control protocol data unit size and the allocated scheduling grant for the user equipment; wherein the at least one medium access control protocol data unit size and the allocated scheduling grant for the user equipment are configured to be used with the serving distributed node to split data between the at least one serving cell and the at least one assisting cell associated with the multiple transmission reception point operation.

Example 15: The apparatus of example 14, wherein the allocated scheduling grant is for uplink and/or downlink scheduling.

Example 16: The apparatus of any one of examples 14 to 15, wherein a change of the at least one medium access control protocol data unit size is indicated using the assisting distributed node with a control protocol data unit or control plane signaling message.

Example 17: The apparatus of any one of examples 14 to 16, wherein the at least one memory and the computer program code are further configured to, with the at least one processor, cause the apparatus at least to: transmit, from the serving distributed node to the assisting distributed node, a command to increase or decrease a size of the allocated scheduling grant, based on a buffer status of the user equipment at the serving distributed node or a buffer status report received from the user equipment.

Example 18: The apparatus of any one of examples 14 to 17, wherein the at least one memory and the computer program code are further configured to, with the at least one processor, cause the apparatus at least to: transmit assistance information from the control plane node to the assisting distributed node, the assistance information comprising an expected minimum and maximum grant.

Example 19: An apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; wherein the serving distributed node determines a data split ratio between the serving cell and the assisting cell associated with inter distributed node multiple transmission reception point operation; wherein the data split ratio between the serving cell and the assisting cell is transmitted from the serving distributed node to the control plane node during a setup of multiple transmission reception point operation; wherein a change in the data split ratio between the serving cell and the assisting cell is transmitted from serving distributed node to the user plane node using a control protocol data unit; transmit a first stream of data from a user plane node to the serving distributed node using a first user plane link; and transmit a second stream of data from the user plane node to the assisting distributed node using a second user plane link.

Example 20: The apparatus of example 19, wherein the serving distributed node comprises a first radio link control buffer and a first hybrid automatic repeat request buffer, and the assisting distributed node comprises a second radio link control buffer and a second hybrid automatic repeat request buffer.

Example 21: The apparatus of example 20, wherein the first hybrid automatic repeat request buffer transmits data of the serving distributed node, and the second hybrid automatic repeat request buffer transmits data of the assisting distributed node.

Example 22: The apparatus of any one of examples 19 to 21, wherein the at least one memory and the computer program code are further configured to, with the at least one processor, cause the apparatus at least to: transmit, from the control plane node over a control link to the serving distributed node, a multiple transmission reception setup request; and transmit, from the serving distributed node over the control link to the control plane node, a response to the multiple transmission reception setup request; wherein the response comprises a cell group configuration including a radio link configuration of the user equipment.

Example 23: The apparatus of any one of examples 19 to 22, wherein the at least one memory and the computer program code are further configured to, with the at least one processor, cause the apparatus at least to: transmit, from the control plane node over a control link to the assisting distributed node, a user equipment context setup request comprising a requested scheduling grant from the assisting cell; wherein the user equipment context setup request is associated with a multiple transmission reception point setup, and comprises a serving cell radio link control configuration; and transmit, from the assisting distributed node over the control link to the control plane node, a response to the user equipment context setup request; wherein the response to the user equipment context setup request comprises a cell group configuration and an allocated scheduling grant from the assisting cell for multiple transmission reception point operation of the user equipment.

Example 24: The apparatus of any one of examples 19 to 23, wherein the at least one memory and the computer program code are further configured to, with the at least one processor, cause the apparatus at least to: transmit, from the control plane node over an interface to the user plane node, a bearer context modification request; wherein the bearer context modification request comprises a serving cell downlink tunnel endpoint identifier and an assisting cell downlink tunnel endpoint identifier and the data split ratio between the serving distributed node and the assisting distributed node; wherein the data split ratio is further between the serving distributed node and the assisting distributed node; and transmit, from the user plane node over the interface to the control plane node, a response to the bearer context modification request.

Example 25: The apparatus of any one of examples 19 to 24, wherein the at least one memory and the computer program code are further configured to, with the at least one processor, cause the apparatus at least to: transmit, from the control plane node to the user equipment, over a control link of the serving distributed node, a first radio resource control message to configure the user equipment with a multiple transmission reception point operation; transmit, from the serving distributed node over the control link to the control plane node, an uplink radio resource control transfer message comprising a second radio resource control payload; transmit an uplink data split ratio between the serving cell and the assisting cell when the user equipment is configured with the multiple and transmission reception point operation; wherein the data split ratio between the serving cell and the assisting cell comprises the uplink data split ratio between the serving cell and the assisting cell.

Example 26: An apparatus includes at least one processor; and at least one memory including computer program code; wherein the at least one memory and the computer program code are configured to, with the at least one processor, cause the apparatus at least to: transmit downlink data to a user equipment for at least one serving cell and at least one assisting cell; receive uplink data from the user equipment for the at least one serving cell and the at least one assisting cell; wherein the at least one serving cell is hosted with a serving distributed node, and the at least one assisting cell is hosted with an assisting distributed node; transmit, from the serving distributed node to the assisting distributed node over an interface, a request for configuring the user equipment with multiple transmission reception point operation; and transmit, from the assisting distributed node to the serving distributed node over the interface, a response to the request for multiple transmission reception point operation.

Example 27: The apparatus of example 26, wherein: the request for multiple transmission reception point operation comprises a multiple transmission reception point radio network temporary identifier and a serving cell uplink tunnel endpoint identifier; and the response to the request for multiple transmission reception point operation comprises an assisting cell downlink tunnel endpoint identifier, at least one assisting cell medium access control protocol data unit size for uplink transmission, at least one assisting cell medium access control protocol data unit size for downlink transmission, an assisting cell uplink scheduling grant, and an assisting cell downlink scheduling grant.

Example 28: The apparatus of any one of examples 26 to 27, wherein the serving distributed node facilitates a radio link control buffer and a hybrid automatic repeat request buffer, where the hybrid automatic repeat request buffer is used for inter distributed unit multi transmission reception point operation.

Example 29: The apparatus of example 28, wherein the hybrid automatic repeat request buffer serves data to the serving distributed node and to the assisting distributed node.

Example 30: The apparatus of any one of examples 26 to 29, wherein buffers of the serving distributed node are used to provide a hybrid automatic repeat request protocol data unit to the assisting distributed node.

Example 31: The apparatus of any one of examples 26 to 30, comprising a data transmission link between the serving distributed node and the user plane node.

Example 32: The apparatus of any one of examples 26 to 31, wherein the at least one memory and the computer program code are further configured to, with the at least one processor, cause the apparatus at least to: transmit, from the serving distributed node to the assisting distributed node over a data interface, a medium access control protocol data unit associated with downlink data; and transmit, from the assisting distributed node to the serving distributed node over the data interface, a medium access control protocol data unit associated with uplink data.

Example 33: The apparatus of any one of examples 26 to 32, wherein the at least one memory and the computer program code are further configured to, with the at least one processor, cause the apparatus at least to: transmit, from the control plane node to the user plane node over an interface, a bearer context setup request; and transmit, from the user plane node to the control plane node over the interface, a response to the bearer context setup request.

Example 34: The apparatus of any one of examples 26 to 33, wherein: a user equipment context setup request comprises a multiple transmission reception point radio network temporary identifier, and a serving cell uplink tunnel endpoint identifier; and a response to the user equipment context setup request comprises a cell group configuration, at least one medium access control protocol data unit size, an assisting cell scheduling grant for the user equipment and a serving cell downlink tunnel endpoint identifier.

Example 35: The apparatus of any one of examples 26 to 34, wherein the at least one memory and the computer program code are further configured to, with the at least one processor, cause the apparatus at least to: transmit, from the control plane node to the user plane node over an interface, a bearer context modification request; wherein the bearer context modification request comprises a multiple transmission reception point radio network temporary identifier and an assisting cell downlink tunnel endpoint identifier; and transmit, from the user plane node to the control plane node over the interface, a response to the bearer context modification request.

Example 36: The apparatus of any one of examples 26 to 35, wherein the at least one memory and the computer program code are further configured to, with the at least one processor, cause the apparatus at least to: transmit, from the control plane node to the serving distributed node over a control link, a downlink radio resource control transfer message comprising a radio resource control configuration; transmit, from the serving distributed node to the control plane node over the control link, an uplink radio resource control transfer message comprising a radio resource control payload; and configure the user equipment with an uplink data split ratio between the at least one serving cell and the at least one assisting cell when uplink multiple transmission reception point operation is configured for the user equipment.

Example 37: A system includes a user equipment; at least one network node that hosts at least one serving cell and at least one assisting cell; wherein the user equipment is configured to receive downlink data from the at least one network node within at least one serving cell and within the at least one assisting cell; wherein the user equipment is configured to transmit uplink data to the at least one network node within the at least one serving cell and within the at least one assisting cell; a serving distributed node; and an assisting distributed node; wherein the serving distributed node and the assisting distributed node is controlled by the same control plane node and exchange information using at least one of the control plane node, at least one user plane link, or a direct interface.

Example 38: The system of example 37, wherein the serving distributed node facilitates a radio link control buffer and a hybrid automatic repeat request buffer.

Example 39: The system of example 38, where the hybrid automatic repeat request buffer is used for inter distributed unit multi transmission reception point operation.

Example 40: The system of any one of examples 38 to 39, wherein the hybrid automatic repeat request buffer serves data to the serving distributed node and to the assisting distributed node.

Example 41: The system of any one of examples 37 to 40, wherein buffers of the serving distributed node are used to provide a hybrid automatic repeat request protocol data unit to the assisting distributed node.

Example 42: The system of any one of examples 37 to 41, wherein the serving distributed node comprises a first radio link control buffer and a first hybrid automatic repeat request buffer, and the assisting distributed node comprises a second radio link control buffer and a second hybrid automatic repeat request buffer.

Example 43: The system of example 42, wherein the first hybrid automatic repeat request buffer serves data to the serving distributed node, and the second hybrid automatic repeat request buffer transmits data to the assisting distributed node.

Example 44: The system of any one of examples 37 to 43, further comprising: a user plane node; and a link between the user plane node and the serving distributed node.

Example 45: An apparatus includes at least one processor; and at least one memory including computer program code; wherein the at least one memory and the computer program code are configured to, with the at least one processor, cause the apparatus at least to: receive uplink data from a user equipment, and transmit downlink data to the user equipment; provide, for the user equipment, access to at least one serving cell; serve, from a hybrid automatic repeat request buffer, data to a serving cell transmission reception point; transmit control plane information to an assisting cell distributed node; and transmit user plane data to the assisting cell distributed node.

Example 46: The apparatus of example 45, wherein the at least one memory and the computer program code are further configured to, with the at least one processor, cause the apparatus at least to: transmit, from the hybrid automatic repeat request buffer, data to an assisting cell transmission reception point.

Example 47: The apparatus of any one of examples 45 to 46, wherein the control plane information is transmitted to the assisting cell distributed node using a control plane node.

Example 48: The apparatus of any one of examples 45 to 47, wherein control plane signaling is transmitted to the assisting cell distributed node using an interface between a serving cell distributed node and the assisting cell distributed node.

Example 49: The apparatus of any one of examples 45 to 48, wherein the user plane data is transmitted to the assisting cell distributed node using either a user plane node, or an interface between a serving cell distributed node and the assisting cell distributed node.

Example 50: The apparatus of any one of examples 45 to 49, wherein a scheduling grant modification request is transmitted to the assisting cell distributed node using a control plane protocol data unit or a control plane signaling message.

Example 51: The apparatus of example 50, wherein the control plane protocol data unit comprises the control plane information, and the control plane protocol data unit is transmitted over a user plane data path.

Example 52: An apparatus includes at least one processor; and at least one memory including computer program code; wherein the at least one memory and the computer program code are configured to, with the at least one processor, cause the apparatus at least to: receive uplink data from a user equipment, and transmit downlink data to the user equipment; provide, for the user equipment, access to at least one assisting cell; receive control plane information from a serving cell distributed node to configure multiple transmission reception point for a user equipment; and receive user plane data from the serving cell distributed node.

Example 53: The apparatus of example 52, wherein the at least one memory and the computer program code are further configured to, with the at least one processor, cause the apparatus at least to: transmit, from a hybrid automatic repeat request buffer of the serving cell, data to an assisting cell transmission reception point.

Example 54: The apparatus of any one of examples 52 to 53, wherein the control plane information is received from the serving cell distributed node using a control plane node.

Example 55: The apparatus of any one of examples 52 to 54, wherein control plane signaling is received from the serving cell distributed node using an interface between the serving cell distributed node and an assisting cell distributed node.

Example 56: The apparatus of any one of examples 52 to 55, wherein the user plane data is received from the serving cell distributed node using either a user plane node, or an interface between the serving cell distributed node and an assisting cell distributed node.

Example 57: An apparatus includes at least one processor; and at least one memory including computer program code; wherein the at least one memory and the computer program code are configured to, with the at least one processor, cause the apparatus at least to: receive a layer 3 measurement report from a user equipment; configure a serving distributed node with multiple transmission reception point operation for a user equipment; receive control plane signaling from the serving distributed node; transmit the control plane signaling to an assisting distributed node; wherein the control plane signaling is configured to be used for multiple transmission reception point operation; and configure the user equipment with multiple transmission reception point operation in downlink and/or uplink.

Example 58: The apparatus of example 57, wherein the at least one memory and the computer program code are further configured to, with the at least one processor, cause the apparatus at least to: transmit to the serving distributed node a user equipment context setup request; and wherein the user equipment context setup request comprises assisting distributed unit node and cell information to setup multiple transmission reception point operation; receive from the serving distributed node a response to the user equipment context setup request; wherein the response comprises a radio network temporary identifier and a tunnel endpoint identifier.

Example 59: The apparatus of any one of examples 57 to 58, wherein the at least one memory and the computer program code are further configured to, with the at least one processor, cause the apparatus at least to: transmit to the assisting distributed node a user equipment context setup request; and receive from the assisting distributed node a response to the user equipment context setup request.

Example 60: The apparatus of example 59, wherein the request comprises a radio network temporary identifier and a serving cell tunnel endpoint identifier, and the response comprises either a cell group configuration or a serving cell radio link control configuration.

Example 61: The apparatus of any one of examples 57 to 60, wherein the at least one memory and the computer program code are further configured to, with the at least one processor, cause the apparatus at least to: transmit a bearer context setup request to a user plane node; receive a response to the bearer context setup request from the user plane node; transmit a bearer context modification request to the user plane node; wherein the bearer context modification request comprises at least one of: a multiple transmission reception point radio network temporary identifier; a serving cell downlink tunnel endpoint identifier; an assisting cell downlink tunnel endpoint identifier; or a data split ratio between the serving distributed node distributed node; receive a response to the bearer context modification request from the user plane node.

Example 62: An apparatus includes at least one processor; and at least one memory including computer program code; wherein the at least one memory and the computer program code are configured to, with the at least one processor, cause the apparatus at least to: receive, from a control plane node, a bearer context setup request; transmit, to the control plane node, a response to the bearer context setup request; receive, from the control plane node, a bearer context modification request; transmit, to the control plane node, a response to the bearer context modification request; wherein the bearer context setup request and the bearer context modification request are related to multiple transmission reception operation; and provide an indication for transparent forwarding as part of the multiple transmission reception point operation.

Example 63: The apparatus of example 62, wherein the indication for transparent forwarding as part of multiple transmission reception point operation is provided to an assisting distributed node.

Example 64: The apparatus of any one of examples 62 to 63, wherein the at least one memory and the computer program code are further configured to, with the at least one processor, cause the apparatus at least to: transparently forward a medium access control protocol data unit to an assisting distributed node in a downlink direction.

Example 65: The apparatus of any one of examples 62 to 64, wherein the at least one memory and the computer program code are further configured to, with the at least one processor, cause the apparatus at least to: transmit downlink data to a serving distributed node; and/or transmit downlink data to an assisting distributed node.

Example 66: The apparatus of any one of examples 62 to 65, wherein the at least one memory and the computer program code are further configured to, with the at least one processor, cause the apparatus at least to: perform a data split for a packet data convergence protocol based on the information provided by serving distributed unit node.

Example 67: The apparatus of any one of examples 62 to 66, wherein the at least one memory and the computer program code are further configured to, with the at least one processor, cause the apparatus at least to: transmit to an assisting distributed node a medium access control protocol data unit associated with a multiple transmission reception point radio network temporary identifier.

Example 68: The apparatus of any one of examples 62 to 67, wherein the bearer context modification request comprises at least one of: a multiple transmission reception point radio network temporary identifier; a serving cell downlink tunnel endpoint identifier; or an assisting cell downlink tunnel endpoint identifier.

Example 69: A method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; transmitting control plane signaling, to configure and manage inter distributed unit multi transmission reception point operation, from the serving distributed node to the assisting distributed node using a control plane node, and transmitting control plane signaling from the assisting distributed node to the serving distributed node using the control plane node; and transmitting user plane data from the serving distributed node to the assisting distributed node using a user plane node for downlink multi transmission reception point operation, and transmitting user plane data from the assisting distributed node to the serving distributed node using the user plane node for uplink multi transmission reception point operation.

Example 70: A method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; wherein the serving distributed node determines a data split ratio between the serving cell and the assisting cell associated with inter distributed node multiple transmission reception point operation; wherein the data split ratio between the serving cell and the assisting cell is transmitted from the serving distributed node to the control plane node during a setup of multiple transmission reception point operation; wherein a change in the data split ratio between the serving cell and the assisting cell is transmitted from serving distributed node to the user plane node using a control protocol data unit; transmitting a first stream of data from a user plane node to the serving distributed node using a first user plane link; and transmitting a second stream of data from the user plane node to the assisting distributed node using a second user plane link.

Example 71: A method includes transmitting downlink data to a user equipment for at least one serving cell and at least one assisting cell; receiving uplink data from the user equipment for the at least one serving cell and the at least one assisting cell; wherein the at least one serving cell is hosted with a serving distributed node, and the at least one assisting cell is hosted with an assisting distributed node; transmitting, from the serving distributed node to the assisting distributed node over an interface, a request for configuring the user equipment with multiple transmission reception point operation; and transmitting, from the assisting distributed node to the serving distributed node over the interface, a response to the request for multiple transmission reception point operation.

Example 72: A method includes receiving uplink data from a user equipment, and transmit downlink data to the user equipment; providing, for the user equipment, access to at least one serving cell; serving, from a hybrid automatic repeat request buffer, data to a serving cell transmission reception point; transmitting control plane information to an assisting cell distributed node; and transmitting user plane data to the assisting cell distributed node.

Example 73: A method includes receiving uplink data from a user equipment, and transmit downlink data to the user equipment; providing, for the user equipment, access to at least one assisting cell; receiving control plane information from a serving cell distributed node to configure multiple transmission reception point for a user equipment; and receiving user plane data from the serving cell distributed node.

Example 74: A method includes receiving a layer 3 measurement report from a user equipment; configuring a serving distributed node with multiple transmission reception point operation for a user equipment; receiving control plane signaling from the serving distributed node; transmitting the control plane signaling to an assisting distributed node; wherein the control plane signaling is configured to be used for multiple transmission reception point operation; and configuring the user equipment with multiple transmission reception point operation in downlink and/or uplink.

Example 75: A method includes receiving, from a control plane node, a bearer context setup request; transmitting, to the control plane node, a response to the bearer context setup request; receiving, from the control plane node, a bearer context modification request; transmitting, to the control plane node, a response to the bearer context modification request; wherein the bearer context setup request and the bearer context modification request are related to multiple transmission reception operation; and providing an indication for transparent forwarding as part of the multiple transmission reception point operation.

Example 76: A non-transitory program storage device readable by a machine, tangibly embodying a program of instructions executable with the machine for performing operations, the operations comprising the method of any of examples 69 to 75.

It should be understood that the foregoing description is only illustrative. Various alternatives and modifications may be devised by those skilled in the art.

For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations may be appended together or with other words/characters, by e.g. using a dash/hyphen, as for example in gNB-CU-CP formed by appending abbreviations gNB and CU-CP, or by appending an ‘s’ to an acronym for plurality e.g. PDUS):
1A 3GPP configuration where user plane data is split in the core network
3C 3GPP configuration where user plane data is split in the MenB
3GPP third generation partnership project
4G fourth generation
5G fifth generation
5GC 5G core network
6G sixth generation
AC assisting cell
Acell assisting cell
ACK or Ack acknowledgement
AMF access and mobility management function
AS access stratum
ASIC application-specific integrated circuit
BBU baseband unit
BCCH broadcast control channel
BSR buffer status report
C control or control plane
CA carrier aggregation
Comp. compression
config configuration
CP control plane
C-plane control plane
CPU central processing unit
C-RAN centralized, clean, cloud, and/or collaborative
RAN
CU central unit or centralized unit
CU-CP central unit control plane
CU-UP central unit user plane
D1 interface between two distributed units
DC dual connectivity
DL downlink
DSP digital signal processor
DU distributed unit
E1 interface connecting a disaggregated user plane to a disaggregated control plane
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 interface between CU and DU, e.g. F1-C or F1-U
feMIMO further enhanced MIMO
FPGA field-programmable gate array
gNB base station for 5G/NR, i.e., a node providing NR user plane and control plane protocol terminations towards the UE, and connected via the NG interface to the 5GC
HARQ hybrid automatic repeat request
ICBM inter-cell beam management
ID identifier
IE information element
I/F interface
I/O input/output
IoT internet of things
L1 layer 1
L2 layer 2
L3 layer 3
LMF location management function
LTE long term evolution (4G)
M2M machine to machine
MAC medium access control
MCG master cell group
MenB master base station controlling the secondary 5G NR base station
MIMO multiple input multiple output
MME mobility management entity
Mod modification
mTRP or MTRP multiple TRP
MR multi-RAT
NCE network control element
ng or NG new generation
ng-eNB new generation eNB
NG-RAN new generation radio access network
NR new radio (5G)
N/W network
O-RAN open radio access network
PCCH paging control channel
PCI physical cell ID
PDCCH physical downlink control channel
PDCP packet data convergence protocol
PDCP (c) PDCP control plane
PDCP (u) PDCP user plane
PDSCH physical downlink shared channel
PDU protocol data unit
PHY physical layer
PKT packet
PS packet scheduler
QoS quality of service
R release

RAN radio access network
RAN #radio layer #, or 3GPP Technical Specification Group Radio Access Network WG # (e.g. RAN1)
RAT radio access technology
RCC radio resource control connection
RE radio equipment
REC radio equipment controller
Rel release
Req request
Res response
RF radio frequency
RLC radio link control
RNTI radio network temporary identifier
RP 3GPP RAN
RRC radio resource control (protocol)
RRH remote radio head
RRU remote radio unit
RU radio unit
Rx receive or receiver or reception
SC serving cell
SCG secondary cell group
SDAP service data adaptation protocol
segm. segmentation
SGW serving gateway
SMF session management function
SN secondary node
SON self-organizing/optimizing network
TCI transmission configuration indicator
TEID tunnel endpoint identifier
TR technical report
TRP transmission reception point
TS technical specification
Tx transmit or transmitter or transmission
U user or user plane
UE user equipment (e.g., a wireless, typically mobile device)
UL uplink
UP user plane
UPF user plane function
V version
V-RAN virtual radio access network
WG working group
WI work item
WID work item description
X2 interface between two radio nodes (e.g. two eNBs)
Xn interface between two NG-RAN nodes

1-76. (canceled)

77. An apparatus comprising:
at least one processor; and
at least one memory including computer program code;
wherein the at least one memory and the computer program code are configured to, with the at least one processor, cause the apparatus at least to:
receive a layer 3 measurement report from a user equipment;
configure a serving distributed node with multiple transmission reception point operation for a user equipment;
receive control plane signaling from the serving distributed node;
transmit the control plane signaling to an assisting distributed node;
wherein the control plane signaling is configured to be used for multiple transmission reception point operation; and
configure the user equipment with multiple transmission reception point operation in downlink and/or uplink.

78. The apparatus of claim 77, wherein the at least one memory and the computer program code are further configured to, with the at least one processor, cause the apparatus at least to:
transmit to the serving distributed node a user equipment context setup request; and
wherein the user equipment context setup request comprises assisting distributed unit node and cell information to setup multiple transmission reception point operation;
receive from the serving distributed node a response to the user equipment context setup request;
wherein the response comprises a radio network temporary identifier and a tunnel endpoint identifier.

79. The apparatus of claim 77, wherein the at least one memory and the computer program code are further configured to, with the at least one processor, cause the apparatus at least to:
transmit to the assisting distributed node a user equipment context setup request; and
receive from the assisting distributed node a response to the user equipment context setup request.

80. The apparatus of claim 79, wherein the request comprises a radio network temporary identifier and a serving cell tunnel endpoint identifier, and the response comprises either a cell group configuration or a serving cell radio link control configuration.

81. The apparatus of claim 77, wherein the at least one memory and the computer program code are further configured to, with the at least one processor, cause the apparatus at least to:
transmit a bearer context setup request to a user plane node;
receive a response to the bearer context setup request from the user plane node;
transmit a bearer context modification request to the user plane node;
wherein the bearer context modification request comprises at least one of:
a multiple transmission reception point radio network temporary identifier:
a serving cell downlink tunnel endpoint identifier;
an assisting cell downlink tunnel endpoint identifier; or
a data split ratio between the serving distributed node and the assisting distributed node;
receive a response to the bearer context modification request from the user plane node.

82. An apparatus comprising:
at least one processor; and
at least one memory including computer program code;
wherein the at least one memory and the computer program code are configured to, with the at least one processor, cause the apparatus at least to:
receive, from a control plane node, a bearer context setup request;
transmit, to the control plane node, a response to the bearer context setup request;
receive, from the control plane node, a bearer context modification request;
transmit, to the control plane node, a response to the bearer context modification request;
wherein the bearer context setup request and the bearer context modification request are related to multiple transmission reception operation; and
provide an indication for transparent forwarding as part of the multiple transmission reception point operation.

83. The apparatus of claim 82, wherein the indication for transparent forwarding as part of multiple transmission reception point operation is provided to an assisting distributed node.

84. The apparatus of claim 82, wherein the at least one memory and the computer program code are further configured to, with the at least one processor, cause the apparatus at least to:
transmit downlink data to a serving distributed node; and/or
transmit downlink data to an assisting distributed node.

85. The apparatus of claim 82, wherein the at least one memory and the computer program code are further configured to, with the at least one processor, cause the apparatus at least to:
perform a data split for a packet data convergence protocol based on the information provided by serving distributed unit node.

86. The apparatus of claim 82, wherein the at least one memory and the computer program code are further configured to, with the at least one processor, cause the apparatus at least to:
transmit to an assisting distributed node a medium access control protocol data unit associated with a multiple transmission reception point radio network temporary identifier.

87. The apparatus of claim 82, wherein the bearer context modification request comprises at least one of:
a multiple transmission reception point radio network temporary identifier;
a serving cell downlink tunnel endpoint identifier; or
an assisting cell downlink tunnel endpoint identifier.

88. A method comprising:
receiving a layer 3 measurement report from a user equipment;
configuring a serving distributed node with multiple transmission reception point operation for a user equipment;
receiving control plane signaling from the serving distributed node;
transmitting the control plane signaling to an assisting distributed node;
wherein the control plane signaling is configured to be used for multiple transmission reception point operation; and
configuring the user equipment with multiple transmission reception point operation in downlink and/or uplink.

89. A method comprising:
receiving, from a control plane node, a bearer context setup request;
transmitting, to the control plane node, a response to the bearer context setup request;
receiving, from the control plane node, a bearer context modification request;
transmitting, to the control plane node, a response to the bearer context modification request;
wherein the bearer context setup request and the bearer context modification request are related to multiple transmission reception operation; and
providing an indication for transparent forwarding as part of the multiple transmission reception point operation.

90. A non-transitory program storage device readable by a machine, tangibly embodying a program of instructions executable with the machine for performing operations, the operations comprising the method of claim 88.
